(19) United States
(12) Patent Application Publication
(10) Pub. No.: US 2025/0027536 A1
(43) Pub. Date: Jan. 23, 2025

(54) ROLLING BEARING, ROTATING DEVICE, AND METHOD FOR MANUFACTURING ROLLING BEARING

(71) Applicant: Seiko Instruments Inc., Chiba-shi (JP)

(72) Inventors: Akihiro IINO, Chiba-shi (JP); Takayuki KOSAKA, Chiba-shi (JP); Haruhiko HASEGAWA, Chiba-shi (JP); Misato HANAOKA, Chiba-shi (JP)

(21) Appl. No.: 18/774,425

(22) Filed: Jul. 16, 2024

(30) Foreign Application Priority Data
Jul. 20, 2023 (JP) 2023-118491
Apr. 12, 2024 (JP) 2024-064960

(51) Int. Cl. F16C 33/10; F16C 19/06; F16C 33/58

(52) U.S. Cl. CPC F16C 33/102; F16C 19/06; F16C 33/58

(57) ABSTRACT

To provide a rolling bearing capable of ensuring durability and reducing rotational resistance. The rolling bearing includes an inner ring and an outer ring disposed coaxially with each other; a rolling body disposed between the inner ring and the outer ring; a sealing member mounted on the outer ring and covering a space between the inner ring and the outer ring from an outer side in an axial direction; and grease disposed between the rolling body and the sealing member. The outer ring has an inner circumferential surface facing the inner ring. The inner circumferential surface is formed with an outer ring raceway surface that supports the rolling body in a rollable manner, and a recessed portion that is provided at a location extending in the axial direction from an end edge of the outer ring raceway surface in the axial direction and is recessed in a radial direction. The grease is in contact with the recessed portion. Unworked penetration of the grease is greater than 178 and less than 287.

### RELATED APPLICATIONS

This application claims priority to Japanese Patent application Nos. JP2023-118491 filed on Jul. 20, 2023 and JP2024-064960 filed Apr. 12, 2024, the entire content of which is incorporated herein by reference.

### BACKGROUND OF THE INVENTION

### 1. Field of the Invention

The present invention relates to a rolling bearing, a rotating device, and a method for manufacturing a rolling bearing.

### 2. Description of the Related Art

In the related art, there is a rolling bearing that holds grease between a pair of bearing rings (an inner ring and an outer ring). In this type of rolling bearing, resistance of the grease may cause an increase in rotational resistance. In the rolling bearing, it is desired to reduce the rotational resistance for the purpose of saving power of a rotating device on which the rolling bearing is mounted. In particular, in a small rolling bearing used in various motors such as a fan motor, there is a strong demand for reduction in rotational resistance.

In order to reduce the rotational resistance of the rolling bearing, it is effective to reduce an amount of grease that comes into contact with both members that rotate relative to each other. Therefore, by applying grease to an end portion of a fixed ring (an outer ring in many cases) of the rolling bearing in an axial direction and a sealing member disposed on the end portion side, an amount of grease that comes into contact with a rolling body (ball) and a cage that holds the rolling body is reduced (for example, see PTL 1). In the rolling bearing disclosed in PTL 1, grease adheres to an inner circumferential surface of the outer ring, avoiding a raceway surface that comes into contact with the rolling body, and is enclosed in an annular shape toward an inner circumferential surface side of the outer ring so as not to come into contact with an outer circumferential surface of an inner ring.

Further, there is a rolling bearing in which a recessed portion is provided in a circumferential surface of a bearing ring and grease is placed in the recessed portion, so that the grease is less likely to come into contact with a rolling body (for example, see PTL 2). PTL 2 discloses the rolling bearing in which an outer ring includes the recessed portion formed on both sides in an axial direction with respect to a raceway surface and a ridge portion formed between the recessed portion and the raceway surface, and the recessed portion includes a placement surface on which grease is placed and an inclined portion formed between the placement surface and the ridge portion and approaching an outer circumferential surface of the outer ring toward an outer side in the axial direction.

### 3. Citations

### Patent Literature

PTL 1: JP2017-150615A
PTL 2: Japanese Patent No. 7209902

### SUMMARY OF THE INVENTION

However, when the amount of grease is reduced in order to reduce the rotational resistance, there is a possibility that a service life of the rolling bearing is shortened due to shortage of grease. As in a configuration disclosed in PTL 2, when the grease is placed on the placement surface of the recessed portion on an opposite side of the ridge portion across the inclined portion, base oil oozing from the grease has to flow along the inclined portion and then goes over the ridge portion until the base oil reaches the raceway surface, and there is a possibility that a supply of the base oil of the grease to the rolling body is insufficient. In particular, since a ratio of a thickener in the grease increases as the base oil oozes from the grease, a base oil supply ability may gradually decrease when the rolling bearing is operated for a long time. Therefore, the rolling bearing in the related art has a problem of ensuring durability and reducing rotational resistance.

Therefore, an object of the invention is to provide a rolling bearing, a rotating device, and a method for manufacturing a rolling bearing, which can ensure durability and reduce rotational resistance.

A rolling bearing according to a first aspect of the invention includes: an inner ring and an outer ring disposed coaxially with each other; a rolling body disposed between the inner ring and the outer ring; a sealing member mounted on the inner ring or the outer ring and covering a space between the inner ring and the outer ring from an outer side in an axial direction; and grease disposed between the rolling body and the sealing member, in which one bearing ring of the inner ring and the outer ring has a circumferential surface facing the other bearing ring, the circumferential surface is formed with a raceway surface that supports the rolling body in a rollable manner, and a recessed portion that is provided at a location extending in the axial direction from an end edge of the raceway surface in the axial direction and is recessed in a radial direction, the grease is in contact with the recessed portion, and unworked penetration of the grease is greater than 178 and less than 287.

According to the first aspect, the recessed portion can restrict the grease from being displaced in the axial direction. Accordingly, it is possible to prevent the grease from being displaced and coming into contact with the rolling body or the like by a desired amount or more. Thus, rotational resistance of the rolling bearing can be reduced. Further, since the grease can be disposed inside the recessed portion, a total amount of the grease can be increased as compared with a configuration in which the recessed portion is not formed.

Further, a portion of the grease that is not in contact with the rolling body and a cage is relatively soft, and oil is easily separated to an outside. Therefore, even when base oil in a portion of the grease that is in contact with the rolling body or the cage is likely to be insufficient, the base oil oozes out to the outside from an inside of the grease that is not in contact with the rolling body and the cage, and the base oil can be continuously supplied to a sliding portion. Even in a state where the grease is applied so as not to be in contact with the rolling body and the cage, the base oil can be supplied from a surface of the grease to the sliding portion, and the base oil oozes out from the inside of the grease onto the surface of the grease, and can be supplied to the sliding portion. Therefore, even when the grease is disposed at a position away from the rolling body and the cage in order to reduce rotational resistance of the rolling bearing, the base oil can be supplied to the sliding portion over a long period of time, and durability of the rolling bearing can be improved.

Since the unworked penetration is less than 287, excessive deformation of the grease by dripping of the grease due to gravity or co-rotation can be prevented, and a shape of the portion of the grease that is not in contact with the rolling body and the cage can be maintained as an initial shape. Accordingly, it is possible to prevent occurrence of variations in the rotational resistance due to a shape of the grease being different for each rolling bearing.

As described above, it is possible to provide a rolling bearing capable of ensuring durability and reducing rotational resistance.

The rolling bearing according to a second aspect of the invention may be configured such that in the rolling bearing according to the first aspect, the grease is in contact with a location of the recessed portion that faces a direction inclined outward in the axial direction with respect to the radial direction.

According to the second aspect, the location of the recessed portion that faces the direction inclined outward in the axial direction with respect to the radial direction restricts the grease from being displaced inward in the axial direction from an initial state. Accordingly, since the grease is less likely to be displaced inward in the axial direction from an initial position in a process of repeated use of the rolling bearing, it is possible to increase an amount of the grease to be enclosed, and it is possible to obtain the above-described operation and effect more reliably.

The rolling bearing according to a third aspect of the invention may be configured such that in the rolling bearing according to the first aspect or the second aspect, the recessed portion has a location that faces a direction inclined inward in the axial direction with respect to the radial direction.

According to the third aspect, the location of the recessed portion that faces the direction inclined inward in the axial direction with respect to the radial direction restricts the grease from being displaced outward in the axial direction. Accordingly, it is possible to prevent the grease or base oil of the grease from flowing out to a sealing member side and leaking from a gap between the sealing member and the one bearing ring.

The rolling bearing according to a fourth aspect of the invention may be configured such that in the rolling bearing according to any one of the first aspect to the third aspect, the grease is in contact with the sealing member.

According to the fourth aspect, when the sealing member is mounted in a state where the grease is applied to the one bearing ring, even when the grease in contact with the sealing member is pressed inward in the axial direction by the sealing member, the grease is restricted, by the recessed portion, from being displaced inward in the axial direction. Therefore, it is possible to prevent the grease from coming into contact with the rolling body or the like by a desired amount or more. Therefore, the rotational resistance of the rolling bearing can be reduced.

The rolling bearing according to a fifth aspect of the invention may be configured such that in the rolling bearing according to any one of the first aspect to the fourth aspect, the grease is in contact with a ridge portion formed at an end edge of the recessed portion on a raceway surface side.

According to the fifth aspect, it is not necessary for the base oil oozing from the grease to go over the ridge portion in a process of reaching the raceway surface, and an insufficient supply of the base oil of the grease to the rolling body can be prevented.

The rolling bearing according to a sixth aspect of the invention may be configured such that in the rolling bearing according to any one of the first aspect to the fifth aspect, the one bearing ring has a protruding portion that protrudes toward the other bearing ring side and on which the circumferential surface is formed, the protruding portion has an end surface that faces outward in the axial direction and is connected to the circumferential surface at a circumferential edge on the other bearing ring side, the circumferential surface has a connection surface formed between the recessed portion and the end surface, and the connection surface is further away from the other bearing ring in the radial direction than an end edge of the raceway surface in the axial direction.

According to the sixth aspect, since the grease is discharged from a nozzle and applied to a predetermined location, when a tip end of the nozzle is inserted into the outer ring and the inner ring from an outside of the rolling bearing, it is possible to make the connection surface less likely to come into contact with the nozzle. Therefore, the nozzle can be easily brought close to the recessed portion when the grease is applied, and productivity of the small-diameter rolling bearing can be improved. Since the nozzle can be easily brought close to the recessed portion, the grease can be accurately applied, and it is possible to prevent the grease from coming into contact with the rolling body or the like by a desired amount or more. Thus, rotational resistance of the rolling bearing can be reduced.

The rolling bearing according to a seventh aspect of the invention may be configured such that in the rolling bearing according to any one of the first aspect to the sixth aspect, the circumferential surface includes an inclined portion extending from an end edge of the recessed portion on a raceway surface side toward the raceway surface side while being inclined with respect to the radial direction and the axial direction.

According to the seventh aspect, even when an end portion of the recessed portion on the raceway surface side extends along the radial direction, the circumferential surface is gradually inclined from the recessed portion toward the raceway surface. Therefore, it is possible to promote flow of the base oil oozing from the grease from the recessed portion along the inclined portion toward the raceway surface. Therefore, even when the grease is not disposed close to the raceway surface, an insufficient supply of the base oil of the grease to the rolling body can be prevented.

The rolling bearing according to an eighth aspect of the invention may be configured such that in the rolling bearing according to the seventh aspect, the grease is disposed so as not to protrude from an inner side of the recessed portion toward an inclined portion side in the radial direction.

According to the eighth aspect, the grease can be prevented from coming into contact with the rolling body. On the other hand, by reducing an amount of the grease applied, it is possible to suitably obtain an effect of preventing an insufficient supply of base oil of the grease to the rolling body as described above.

The rolling bearing according to a ninth aspect of the invention may be configured such that in the rolling bearing according to any one of the first aspect to the eighth aspect, a difference between worked penetration and the unworked penetration of the grease is less than 50.

According to the ninth aspect, softness of a portion of the grease that is not in contact with the rolling body and the cage is close to softness of a portion of the grease that is in contact with the rolling body and the cage. Accordingly, a difference in a degree of oozing of the base oil between the portion of the grease that is in contact with the rolling body or the cage and the portion of the grease that is not in contact with the rolling body and the cage is reduced. Therefore, the rotational resistance of the rolling bearing can be stabilized for a long period of time.

The rolling bearing according to a tenth aspect of the invention may be configured such that in the rolling bearing according to any one of the first aspect to the ninth aspect, a ratio of a difference between worked penetration and the unworked penetration to the worked penetration of the grease is less than 22.7%.

According to the tenth aspect, softness of a portion of the grease that is not in contact with the rolling body and the cage is close to softness of a portion of the grease that is in contact with the rolling body or the cage. Accordingly, a difference in a degree of oozing of the base oil between the portion of the grease that is in contact with the rolling body or the cage and the portion of the grease that is not in contact with the rolling body and the cage is reduced. Therefore, the rotational resistance of the rolling bearing can be stabilized for a long period of time.

The rolling bearing according to an eleventh aspect of the invention may be configured such that in the rolling bearing according to any one of the first aspect to the tenth aspect, unworked penetration of the grease after standing at 85° C. for 18 hours is greater than 158.

According to the eleventh aspect, a degree of hardening of the grease can be set to such an extent that the base oil oozes out smoothly, even when the grease is exposed to a high temperature or left to stand for a long time. Therefore, the rolling bearing having high durability can be formed.

A rotating device according to a twelfth aspect of the invention includes: a rotating body disposed to be rotatable; a support body rotatably supporting the rotating body; and the rolling bearing according to any one of the first aspect to the eleventh aspect interposed between the rotating body and the support body.

According to the twelfth aspect, by including the rolling bearing that ensures durability and reduces rotational resistance, it is possible to achieve a long service life of the rotating device and to achieve power saving of the rotating device by reduction in rotational resistance of the rotating body with respect to the support body.

A method for manufacturing a rolling bearing according to a thirteenth aspect of the invention is a method for manufacturing a rolling bearing, the rolling bearing including an inner ring and an outer ring disposed coaxially with each other, a rolling body disposed between the inner ring and the outer ring, a sealing member mounted on the inner ring or the outer ring and covering a space between the inner ring and the outer ring from an outer side in an axial direction, and grease disposed between the rolling body and the sealing member, one bearing ring of the inner ring and the outer ring having a circumferential surface facing the other bearing ring, and the circumferential surface being formed with a raceway surface that supports the rolling body in a rollable manner, and a recessed portion that is provided at a location extending in the axial direction from an end edge of the raceway surface in the axial direction and is recessed in a radial direction, and the method for manufacturing a rolling bearing includes: an application step of applying the grease by bringing the grease into contact with the recessed portion, in which unworked penetration of the grease is greater than 178 and less than 287.

According to the thirteenth aspect, the grease can be applied to the one bearing ring so that the displacement in the axial direction is restricted by the recessed portion. Accordingly, it is possible to prevent the grease from being displaced and coming into contact with the rolling body or the like by a desired amount or more. Thus, rotational resistance of the rolling bearing can be reduced. Further, since the grease can be disposed inside the recessed portion, a total amount of the grease can be increased as compared with a case where the grease is not applied to the recessed portion. Further, since the unworked penetration of the grease is relatively small, the grease can be easily deformed in the radial direction when the grease is pressed inward in the axial direction by the sealing member. Accordingly, it is possible to prevent the grease from moving inward in the axial direction and to prevent the grease from coming into contact with the rolling body or the cage more than necessary. As described above, it is possible to manufacture a rolling bearing capable of ensuring durability and reducing rotational resistance.

The rolling bearing according to a fourteenth aspect of the invention may be configured such that in the rolling bearing according to the thirteenth aspect, the sealing member includes an annular pedestal portion that is in contact with the one bearing ring from the outer side in the axial direction, an extension portion that extends outward in the axial direction from a circumferential edge of the pedestal portion on the other bearing ring side of the inner ring and the outer ring, and a planar portion that extends along the radial direction from an end edge of the extension portion on the outer side in the axial direction toward the other bearing ring, in the application step, the grease is applied so as to protrude outward in the axial direction and toward the other bearing ring side from a contact portion with the one bearing ring, and the method for manufacturing a rolling bearing further includes: a contact step of bringing the sealing member close to the one bearing ring from the outer side in the axial direction and bringing the planar portion into contact with an end edge of the grease on the outer side in the axial direction; and after the contact step, a mounting step of bringing the sealing member close to the one bearing ring to bring the pedestal portion into contact with the one bearing ring from the outer side in the axial direction, and pressing the grease inward in the axial direction by the planar portion.

According to the fourteenth aspect, since the planar portion of the sealing member comes into contact with the end edge of the grease on the outer side in the axial direction in the contact step, it is possible to provide a space for the grease to spread in the radial direction toward the extension portion and the pedestal portion of the sealing member in a process of being pressed inward in the axial direction by the planar portion in the mounting step. Therefore, the grease can be prevented from spreading largely toward the other bearing ring side and the rolling body side. Thus, the grease can be easily prevented from directly contacting the rolling body and the other bearing ring.

In addition, since the extension portion is provided between the planar portion and the pedestal portion, the grease is less likely to be pressed toward the rolling body side than in a configuration in which the planar portion extends from the pedestal portion toward the other bearing ring side. Thus, the grease can be disposed in advance to a position closer to the rolling body, and thus an amount of grease can be increased.

According to the invention, it is possible to provide the rolling bearing, the rotating device, and the method for manufacturing a rolling bearing, which can ensure durability and reduce rotational resistance.

### BRIEF DESCRIPTION OF THE DRAWINGS

FIG. 1 is a plan view of a rolling bearing according to a first embodiment.

FIG. 2 is a longitudinal cross-sectional view taken along line II-II in FIG. 1.

FIG. 3 is a longitudinal cross-sectional view of the rolling bearing showing a grease application method according to the first embodiment.

FIG. 4 is a longitudinal cross-sectional view of the rolling bearing showing a grease application method according to the first embodiment.

FIG. 5 is a longitudinal cross-sectional view of a rolling bearing according to a first modification of the first embodiment.

FIG. 6 is a longitudinal cross-sectional view of a rolling bearing according to a second modification of the first embodiment.

FIG. 7 is a longitudinal cross-sectional view of a rolling bearing according to a third modification of the first embodiment.

FIG. 8 is a longitudinal cross-sectional view of a rolling bearing according to a fourth modification of the first embodiment.

FIG. 9 is a longitudinal cross-sectional view of a rolling bearing according to a second embodiment.

FIG. 10 is a longitudinal cross-sectional view of a rolling bearing according to a third embodiment.

FIG. 11 is a longitudinal cross-sectional view of a rolling bearing according to a fifth embodiment.

FIG. 12 is a longitudinal cross-sectional view of a rolling bearing according to a modification of the fifth embodiment.

FIG. 13 is a longitudinal cross-sectional view of a rolling bearing according to a sixth embodiment.

FIG. 14 is a longitudinal cross-sectional view of a rolling bearing according to a first modification of the sixth embodiment.

FIG. 15 is a longitudinal cross-sectional view of a rolling bearing according to a second modification of the sixth embodiment.

FIG. 16 is a longitudinal cross-sectional view of a rolling bearing according to a seventh embodiment.

FIG. 17 is a longitudinal cross-sectional view of a rolling bearing according to a first modification of the seventh embodiment.

FIG. 18 is a longitudinal cross-sectional view of a rolling bearing according to a second modification of the seventh embodiment.

FIG. 19 is a longitudinal cross-sectional view of a rolling bearing according to an eighth embodiment.

FIG. 20 is a longitudinal cross-sectional view of a rolling bearing according to a ninth embodiment.

FIG. 21 is a longitudinal cross-sectional view of a rolling bearing according to a first modification of the ninth embodiment.

FIG. 22 is a longitudinal cross-sectional view of a rolling bearing according to a second modification of the ninth embodiment.

### DESCRIPTION OF EMBODIMENTS

Hereinafter, embodiments of the invention will be described with reference to the drawings. In the following description, components having the same or similar functions are denoted by the same reference signs. A redundant description of the configuration may be omitted.

### First Embodiment

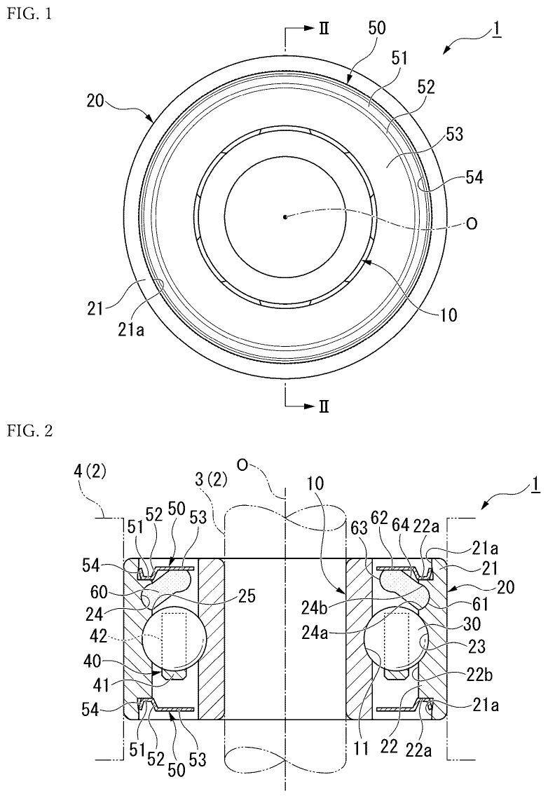

A first embodiment of the invention will be described with reference to FIGS. 1 and 2.

FIG. 1 is a plan view of a rolling bearing according to the first embodiment. FIG. 2 is a longitudinal cross-sectional view taken along line II-II in FIG. 1. In FIG. 2, a rotating device 2 on which a rolling bearing 1 is mounted is indicated by a virtual line.

As shown in FIGS. 1 and 2, the rolling bearing 1 is a radial ball bearing including an inner ring 10 and an outer ring 20 that are bearing rings, a plurality of rolling bodies 30, a cage 40, and a pair of sealing members 50. The rolling bearing 1 is provided in the rotating device 2 such as a fan motor. The rotating device 2 includes a shaft 3 (rotating body) that is rotatable about a common axis O, and a housing 4 (support body) fixedly disposed to rotatably support the shaft 3. The rolling bearing 1 is interposed between the shaft 3 and the housing 4.

The inner ring 10 and the outer ring 20 are disposed coaxially with each other such that their central axes coincide with the common axis O. In the present embodiment, a direction in which the common axis O extends is referred to as an axial direction, a direction orthogonal to the common axis O and extending radially from the common axis O is referred to as a radial direction, and a direction around the common axis O is referred to as a circumferential direction. One of directions parallel to the axial direction and oriented in opposite directions is defined as an upward direction, and the other is defined as a downward direction.

The inner ring 10 is provided as a rotating ring. The inner ring 10 is fitted onto the shaft 3 and fixed to the shaft 3. The outer ring 20 is provided as a fixed ring. The outer ring 20 is fitted into a recessed portion (or a through hole) of the housing 4 and is fixed to the housing 4. The outer ring 20 surrounds the inner ring 10 from an outside of the inner ring 10 in the radial direction in a state where an annular space is provided between the outer ring 20 and the inner ring 10. The plurality of rolling bodies 30 are disposed between the inner ring 10 and the outer ring 20, and are held by the cage 40 in a rollable manner. The cage 40 rotatably holds the rolling bodies 30 in a state where the plurality of rolling bodies 30 are disposed evenly in the circumferential direction. The sealing member 50 is mounted on the outer ring 20 and covers an annular space between the inner ring 10 and the outer ring 20 from an outside in the axial direction.

The outer ring 20 is formed into an annular shape with a metal material such as stainless steel or bearing steel. The outer ring 20 is not limited to being made of metal, and may be made of other materials. The outer ring 20 includes an outer ring body 21 having a width along the axial direction equal to a width of the inner ring 10 along the axial direction, and a protruding portion 22 protruding inward in the radial direction from the outer ring body 21 and extending throughout the circumferential direction. The protruding portion 22 is formed in a portion of the outer ring body 21 located at a center in the axial direction. A width of the protruding portion 22 in the axial direction is smaller than the width of the outer ring body 21 in the axial direction and larger than an outer diameter of the rolling body 30.

The protruding portion 22 includes a pair of end surfaces 22a facing outward in the axial direction and an inner circumferential surface 22b (circumferential surface) connecting inner circumferential edges of the pair of end surfaces 22a. The end surfaces 22a extend parallel to each other in the radial direction and circumferential direction. An outer ring raceway surface 23 recessed outward in the radial direction is formed on the inner circumferential surface 22b. The outer ring raceway surface 23 is formed in a hemispherical shape in a cross-sectional view along an outer surface of the rolling body 30, and is formed in an annular shape extending in the circumferential direction over an entire circumference of the inner circumferential surface 22b. The outer ring raceway surface 23 is formed in a portion of the inner circumferential surface 22b located at a center in the axial direction.

Further, a recessed portion 24 recessed outward in the radial direction is formed in the inner circumferential surface 22b. The recessed portion 24 is provided at a location of the inner circumferential surface 22b extending in the axial direction from an end edge of the outer ring raceway surface 23 in the axial direction. The recessed portion 24 is provided above the outer ring raceway surface 23. The recessed portion 24 is provided with an interval in the axial direction with respect to the outer ring raceway surface 23. The recessed portion 24 is provided with an interval in the axial direction with respect to the end surface 22a facing upward. The recessed portion 24 continuously extends throughout the circumferential direction. The recessed portion 24 extends in an arc shape on a longitudinal cross section of the rolling bearing 1. For example, on the longitudinal cross section of the rolling bearing 1, a radius of curvature of the recessed portion 24 may be equal to or different from a radius of curvature of the outer ring raceway surface 23. The recessed portion 24 may not extend at a constant curvature on the longitudinal cross section of the rolling bearing 1. The recessed portion 24 includes an outward facing surface 24a facing a direction inclined outward in the axial direction with respect to the radial direction (inward and upward in the radial direction, or upward), and an inward facing surface 24b facing a direction inclined inward in the axial direction with respect to the radial direction (inward and downward in the radial direction, or downward). A portion of the inner circumferential surface 22b excluding the outer ring raceway surface 23 and the recessed portion 24 extends in the axial direction with a constant inner diameter.

The inner circumferential surface 22b includes a ridge portion 25 formed at an end edge of the recessed portion 24 on an outer ring raceway surface 23 side (inner side in the axial direction). The ridge portion 25 may be rounded or pointed on the longitudinal cross section of the rolling bearing 1.

The outer ring body 21 has a pair of inner circumferential surfaces 21a extending from an outer circumferential edge of each end surface 22a of the protruding portion 22 to an opening edge of the outer ring 20. A portion of each inner circumferential surface 21a located on an inner side in the axial direction is located on an outer side in the radial direction relative to a portion located on an outer side in the axial direction.

The inner ring 10 is formed into an annular shape with a metal material such as stainless steel or bearing steel. The inner ring 10 is not limited to being made of metal, and may be made of other materials. An inner ring raceway surface 11 recessed inward in the radial direction is formed on an outer circumferential surface of the inner ring 10. The inner ring raceway surface 11 is formed in a hemispherical shape in the cross-sectional view along the outer surface of the rolling body 30, and is formed in an annular shape extending in the circumferential direction over an entire circumference of the outer circumferential surface. The inner ring raceway surface 11 is formed in a portion of the outer circumferential surface of the inner ring 10 located at a center in the axial direction, and faces the outer ring raceway surface 23 in the radial direction. A portion of the outer circumferential surface of the inner ring 10 excluding the inner ring raceway surface 11 extends in the axial direction with a constant outer diameter.

As shown in FIG. 2, the plurality of rolling bodies 30 are formed into a spherical shape with a metal material such as stainless steel or bearing steel. The plurality of rolling bodies 30 are disposed between the outer ring raceway surface 23 and the inner ring raceway surface 11, and are supported by the outer ring raceway surface 23 and the inner ring raceway surface 11 in a rollable manner. The plurality of rolling bodies 30 are maintained at intervals in the circumferential direction by the cage 40.

The cage 40 is formed into an annular shape as a whole with a synthetic resin or a metal material. The cage 40 is disposed around the common axis O. The cage 40 includes an annular portion 41 formed in an annular shape and disposed below the plurality of rolling bodies 30, and a plurality of column portions 42 protruding upward from the annular portion 41 and provided at intervals in the circumferential direction. The column portions 42 are disposed evenly in the circumferential direction. A pair of column portions 42 adjacent to each other in the circumferential direction form a ball pocket therebetween. The ball pocket penetrates through the cage 40 in the radial direction, and opens upward at an upper end surface of the cage 40. The ball pockets are provided corresponding to the number of the rolling bodies 30, and hold the rolling bodies 30 in a rollable manner individually. Accordingly, the cage 40 arranges the rolling bodies 30 evenly at intervals in the circumferential direction. The cage 40 is disposed with a gap from the inner ring 10 and the outer ring 20 so as not to interfere with the inner ring 10 and the outer ring 20. In the present embodiment, the entire cage 40 is located on the inner side in the axial direction relative to the pair of end surfaces 22a of the protruding portion 22 of the outer ring 20.

As shown in FIGS. 1 and 2, the sealing member 50 is formed in an annular plate shape. The sealing member 50 is disposed around the common axis O. The sealing member 50 is uniformly formed over the entire circumference. The sealing member 50 is fitted into the outer ring 20 from the outside in the axial direction. One sealing members 50 is disposed on each side of the plurality of rolling bodies 30 in the axial direction. The sealing member 50 includes an annular pedestal portion 51 that comes into contact with the outer ring 20 from the outside in the axial direction, an extension portion 52 that extends outward in the axial direction from an inner circumferential edge of the pedestal portion 51, a planar portion 53 that extends along the radial direction from an end edge of the extension portion 52 on the outer side in the axial direction toward the inner ring 10, and a locking portion 54 that extends outward in the radial direction and outward in the axial direction from an outer circumferential edge of the pedestal portion 51.

As shown in FIG. 2, the pedestal portion 51 overlaps the end surface 22a of the protruding portion 22 of the outer ring 20 from the outside in the axial direction. The pedestal portion 51 extends substantially parallel to the end surface 22a of the protruding portion 22 of the outer ring 20. The pedestal portion 51 protrudes inward in the radial direction from the end surface 22a of the protruding portion 22 in a plan view viewed from the axial direction. A distance by which the pedestal portion 51 protrudes inward in the radial direction from the end surface 22a of the protruding portion 22 is 10% or less, and preferably 5% or less, of an interval between the inner ring 10 and the outer ring 20 in the radial direction. The extension portion 52 extends outward in the axial direction and inward in the radial direction from the inner circumferential edge of the pedestal portion 51. The planar portion 53 overlaps a center of the rolling body 30 in the plan view. An inner circumferential edge of the planar portion 53 is disposed at the outer circumferential surface of the inner ring 10 with a gap therebetween. A surface of the planar portion 53 facing inward in the axial direction is a flat surface extending in the circumferential direction and the radial direction. An outer circumferential edge of the locking portion 54 is locked to the inner circumferential surface 21a of the outer ring body 21 from the inner side in the axial direction. Accordingly, the sealing member 50 is fixed to the outer ring 20 and rotates integrally with the outer ring 20 with respect to the inner ring 10.

The rolling bearing 1 is enclosed with grease 60. The grease 60 is disposed between the rolling body 30 and the sealing member 50. The grease 60 is disposed on the same side in the annular space between the inner ring 10 and the outer ring 20 as the recessed portion 24 facing the rolling body 30 in the axial direction. In the present embodiment, the grease 60 is disposed on an opposite side of the annular portion 41 of the cage 40 across the rolling body 30 in the axial direction. The grease 60 is disposed above the rolling body 30. The grease 60 is disposed along the circumferential direction. The grease 60 extends in an annular shape or an arc shape, and is disposed coaxially with the common axis O.

The grease 60 includes the outer ring contact portion 61 that is in contact with the inner circumferential surface 22b of the protruding portion 22 of the outer ring 20, and the sealing member contact portion 62 that is in contact with the planar portion 53 of the sealing member 50 on the outer side in the axial direction and the inner side in the radial direction relative to the outer ring contact portion 61. The outer ring contact portion 61 and the sealing member contact portion 62 extend in the circumferential direction over an entire length of the grease 60. The outer ring contact portion 61 has a width in the axial direction throughout the circumferential direction. The outer ring contact portion 61 is in contact with the recessed portion 24 of the inner circumferential surface 22b of the protruding portion 22. The outer ring contact portion 61 is in contact with the recessed portion 24 over an entire circumference. The outer ring contact portion 61 is in contact with the outward facing surface 24a of the recessed portion 24. In this case, the outer ring contact portion 61 is preferably in contact with at least a part of the ridge portion 25. In the present embodiment, the outer ring contact portion 61 is in contact with the ridge portion 25 over the entire circumference. Further, the outer ring contact portion 61 is in contact with the inward facing surface 24b of the recessed portion 24 and a location of the recessed portion 24 facing inward in the radial direction. In the present embodiment, the outer ring contact portion 61 is in contact with the entire recessed portion 24. The grease 60 is preferably not in contact with a location of the outer ring 20 other than the recessed portion 24. That is, the outer ring contact portion 61 is provided with an interval in the axial direction with respect to a contact portion between the outer ring 20 and the pedestal portion 51 of the sealing member 50. The sealing member contact portion 62 has a width in the radial direction throughout the circumferential direction. The sealing member contact portion 62 is in contact with the planar portion 53 at a location with an interval in the radial direction from a connection portion between the extension portion 52 and the planar portion 53 of the sealing member 50.

The grease 60 extends outward in the axial direction and inward in the radial direction from the outer ring contact portion 61 toward the sealing member contact portion 62. The grease 60 includes an inner surface 63 and an outer surface 64.

The inner surface 63 connects an end edge of the outer ring contact portion 61 on the inner side in the axial direction and an end edge of the sealing member contact portion 62 on the inner side in the radial direction. The inner surface 63 faces the outer circumferential surface of the inner ring 10 and the rolling body 30. An upper half portion of the inner surface 63 extends inward in the axial direction and inward in the radial direction from the end edge of the sealing member contact portion 62 on the inner side in the radial direction. A lower half portion of the inner surface 63 extends outward in the axial direction and inward in the radial direction from the end edge of the outer ring contact portion 61 on the inner side in the axial direction and is connected to a lower end edge of the upper half portion. A boundary portion between the upper half portion and the lower half portion of the inner surface 63 forms an inner circumferential edge located on the innermost side of the grease 60 in the radial direction. The inner surface 63 is separated from the inner ring 10, the rolling body 30, and the cage 40. Accordingly, the grease 60 does not come into contact with the inner ring 10, the rolling body 30, and the cage 40.

The outer surface 64 connects an end edge of the outer ring contact portion 61 on the outer side in the axial direction and an end edge of the sealing member contact portion 62 on the outer side in the radial direction. The outer surface 64 faces the inner circumferential surface 22b of the protruding portion 22 of the outer ring 20 and the sealing member 50. The outer surface 64 extends inward in the axial direction and outward in the radial direction from the end edge of the sealing member contact portion 62 on the outer side in the radial direction, and is connected to the end edge of the outer ring contact portion 61 on the outer side in the axial direction. The outer surface 64 is separated from the pedestal portion 51 and the extension portion 52 of the sealing member 50. Accordingly, the grease 60 does not come into contact with the pedestal portion 51 and the extension portion 52 of the sealing member 50 located closer to an outer ring 20 side than the planar portion 53.

The grease 60 is formed such that a cross-sectional area of a cross section along a vertical plane of the common axis O gradually increases from an end portion on the outer side in the axial direction toward the inner side in the axial direction. In the present embodiment, the grease 60 is formed such that the cross-sectional area of the cross section along the vertical plane of the common axis O gradually increases from the end portion on the outer side in the axial direction toward the inner side in the axial direction, in a portion corresponding to the upper half portion of the inner surface 63.

The grease 60 may be in contact with at least one of the rolling body 30 and the cage 40. For example, the grease 60 may come into contact with at least one of the rolling body 30 and the cage 40 from an initial state in which the grease 60 is not in contact with the rolling body 30 and the cage 40 due to a change over time.

A configuration of the grease 60 will be described. The grease 60 may contain components other than base oil and a thickener as necessary.

The base oil is not particularly limited, and examples thereof include mineral oil and synthetic oil. As the mineral oil, known mineral oil used as the base oil can be used, and examples thereof include naphthenic mineral oil, paraffinic mineral oil, hydrogenated mineral oil, solvent-refined mineral oil, and highly refined mineral oil. The mineral oil may be used alone or in combination of two or more types thereof. For example, a plurality of types of mineral oil may be mixed and adjusted to desired properties.

As the synthetic oil, known synthetic oil used as the base oil can be used, and examples thereof include aliphatic hydrocarbon oil such as a poly-α-olefin (PAO) and a polybutene; aromatic hydrocarbon oil such as an alkylbenzene and an alkylnaphthalene; ester oil such as a polyol ester and a phosphate ester; ether oil such as a polyphenyl ether; a polyalkylene glycol oil; silicone oil; and fluorine oil. These types of synthetic oil may be used alone or in combination of two or more types thereof. For example, a plurality of types of synthetic oil may be mixed and adjusted to desired properties.

The thickener serves to keep the grease 60 in a semi-solid state. As the thickener, a known thickener commonly used for grease for a rolling bearing can be used without limitation. Examples of the thickener include a urea compound, a lithium soap, a calcium soap, a composite lithium soap, a composite calcium soap, a silica gel, polytetrafluoroethylene, and an organic bentonite. The thickener is preferably a urea compound from a viewpoint of excellent heat resistance. The thickener may be used alone or in combination of two or more types thereof. For example, a plurality of types of thickeners may be mixed and adjusted to desired properties.

Unworked penetration of the grease 60 in the present embodiment is greater than 178 and less than 287. A difference between worked penetration and the unworked penetration of the grease 60 is preferably less than 50. A ratio of the difference between the worked penetration and the unworked penetration to the worked penetration of the grease 60 is preferably less than 22.7%. The unworked penetration of the grease 60 after standing at 85° C. for 18 hours is preferably greater than 158. In the following description, standing at 85° C. for 18 hours is referred to as high-temperature standing.

Next, a method for manufacturing the rolling bearing 1 according to the present embodiment will be described.

The method for manufacturing the rolling bearing 1 according to the present embodiment includes an application step and a sealing step.

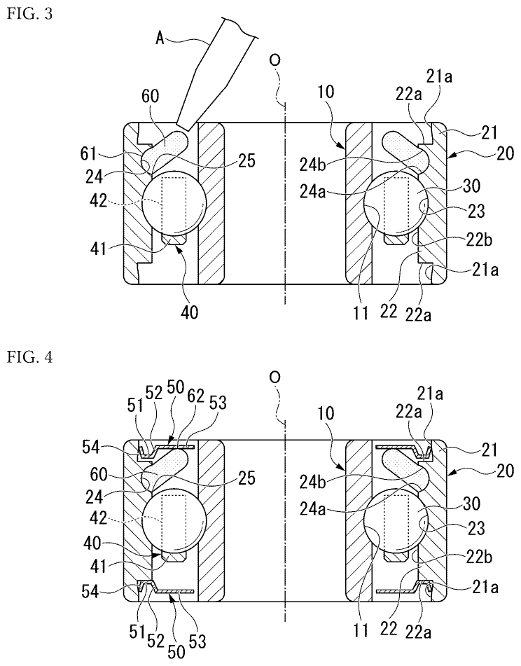

FIGS. 3 and 4 are longitudinal cross-sectional views of the rolling bearing showing a grease application method according to the first embodiment.

As shown in FIG. 3, the application step is performed in a state where the sealing member 50 is not attached to the outer ring 20. That is, the grease 60 is applied in a state where the annular space between the inner ring 10 and the outer ring 20 is opened in the axial direction and the rolling body 30 and the cage 40 are exposed. In the application step, the grease 60 is discharged from a nozzle A while the nozzle A is rotated about the common axis O with respect to the outer ring 20. At this time, an orientation of the nozzle A is adjusted so that the grease 60 is discharged from the nozzle A to the outer side in the radial direction and the inner side in the axial direction. Further, the discharged grease 60 is brought into contact with the recessed portion 24 of the inner circumferential surface 22b of the protruding portion 22 of the outer ring 20, and a position of the nozzle A is adjusted so that the grease 60 does not come into contact with the rolling body 30 and the cage 40. By discharging the grease 60 while rotating the nozzle A relative to the outer ring 20, the grease 60 applied to the outer ring 20 extends in a circumferential shape or an arc shape. The grease 60 is applied along a discharge direction from the nozzle A so as to project outward in the axial direction and inward in the radial direction from a contact portion with the outer ring 20. An outer end surface of the applied grease 60 in the axial direction is formed in a projecting manner bulging outward in the axial direction.

Subsequently, the sealing step is performed. As shown in FIG. 4, in the sealing step, the sealing member 50 is mounted on the outer ring 20 by bringing the sealing member 50 closer to the outer ring 20 from the outer side in the axial direction. In a process of displacing the sealing member 50 inward in the axial direction, before the pedestal portion 51 comes into contact with the end surface 22a of the protruding portion 22 of the outer ring 20, the planar portion 53 of the sealing member 50 is first brought into contact with an end edge of the entire grease 60 on the outer side in the axial direction (contact step). At this time, the grease 60 is brought into contact with an intermediate portion of the planar portion 53 in the radial direction. The intermediate portion in the radial direction may be located inward in the radial direction relative to an outer circumferential edge of the planar portion 53 and outward in the radial direction relative to an inner circumferential edge of the planar portion 53. Thereafter, the sealing member 50 is further brought close to the outer ring 20 to bring the pedestal portion 51 into contact with the end surface 22a of the protruding portion 22 of the outer ring 20 from the outer side in the axial direction (mounting step). At this time, the grease 60 is pressed inward in the axial direction by the planar portion 53 of the sealing member 50. Accordingly, the grease 60 spreads in the radial direction by being pressed by the planar portion 53, and the sealing member contact portion 62 of the grease 60 is formed.

As described above, the rolling bearing 1 is formed. In the application step according to the present embodiment, the grease 60 is applied while the nozzle A is rotated with respect to the outer ring 20. However, the grease may be discharged from a nozzle having a discharge hole extending in the circumferential direction, and the grease may be collectively applied in a circumferential shape or an arc shape.

As described above, in the present embodiment, the rolling bearing 1 has the following configuration. The inner circumferential surface 22b of the protruding portion 22 of the outer ring 20 is formed with the outer ring raceway surface 23 that supports the rolling body 30 in a rollable manner, and the recessed portion 24 that is provided at a location extending in the axial direction from the end edge of the outer ring raceway surface 23 in the axial direction and is recessed in the radial direction. The grease 60 is in contact with the recessed portion 24. According to this configuration, displacement of the grease 60 in the axial direction can be restricted by the recessed portion 24. Accordingly, it is possible to prevent the grease 60 from being displaced and coming into contact with the rolling body 30 or the cage 40 by a desired amount or more. Thus, rotational resistance of the rolling bearing 1 can be reduced. Further, since the grease 60 can be disposed inside the recessed portion 24, a total amount of the grease 60 can be increased as compared with a configuration in which the recessed portion is not formed.

Here, the grease 60 is disposed between the rolling body 30 and the sealing member 50, and most of (or the entire) the grease 60 is not in contact with the rolling body 30 and the cage 40. That is, only a small portion of the grease 60 comes into contact with the rolling body 30 or the cage 40 and is subjected to shearing during an operation of the rolling bearing 1, and the grease 60 may not come into contact with the rolling body 30 and the cage 40.

The grease has different hardness between a state in which the grease is not subjected to shearing (a state of being unworked) and a state in which the grease is subjected to shearing (a state of being worked). In general, the grease becomes soft when being subjected to shearing. Therefore, a portion of the grease 60 that is in contact with the inner ring 10, the rolling body 30, or the cage 40 is continuously subjected to shearing from the rolling body 30 or the cage 40 and becomes soft, thereby promoting oozing of the base oil. On the other hand, a portion of the grease 60 that is not in contact with the rolling body 30 and the cage 40 remains in a hard state. In a case where a portion of the grease 60 that is in contact with the rolling body 30 or the cage 40 is small, when the base oil that oozes out from the portion that is subjected to shearing by the rolling body 30 or the cage 40 is insufficient, most of the grease 60 is not stirred and remains in a hard state, a supply of the base oil is insufficient and a service life of the rolling bearing 1 expires. The same applies to a case where the entire grease 60 is not in contact with the rolling body 30 and the cage 40.

There are worked penetration and unworked penetration as an index indicating properties related to hardness of grease. The worked penetration is an index of the hardness of the grease immediately after being subjected to shearing. Therefore, a state of the grease at the time of measuring the worked penetration is close to a state of a portion of the grease that comes into contact with the rolling body or the cage and is subjected to shearing in the rolling bearing. On the other hand, the unworked penetration is an index of the hardness of the grease in a state of not being subjected to shearing. Therefore, a state of the grease at the time of measuring the unworked penetration is close to a state of a portion of the grease that is not in contact with the rolling body and the cage in the rolling bearing.

In the present embodiment, the unworked penetration of the grease 60 is greater than 178 and less than 287. According to this configuration, the portion of the grease 60 that is not in contact with the rolling body 30 and the cage 40 is relatively soft, and oil is easily separated to an outside. Therefore, even when base oil in the portion of the grease 60 that is in contact with the rolling body 30 or the cage 40 is likely to be insufficient, the base oil oozes out to the outside from an inside of the grease 60 that is not in contact with the rolling body 30 and the cage 40, and the base oil can be continuously supplied to a sliding portion. Even in a state where the grease 60 is applied so as not to be in contact with the rolling body 30 and the cage 40, the base oil can be supplied from a surface of the grease 60 to the sliding portion, and the base oil oozes out from an inside of the grease 60 onto the surface of the grease 60, and can be supplied to the sliding portion. Therefore, even when the grease 60 is disposed at a position away from the rolling body 30 and the cage 40 in order to reduce rotational resistance of the rolling bearing 1, the base oil can be supplied to the sliding portion over a long period of time, and durability of the rolling bearing 1 can be improved.

Since the unworked penetration is less than 287, excessive deformation of the grease by dripping of the grease 60 due to gravity or co-rotation can be prevented, and a shape of the portion of the grease 60 that is not in contact with the rolling body 30 and the cage 40 can be maintained as an initial shape. Accordingly, it is possible to prevent occurrence of variations in the rotational resistance due to a shape of the grease 60 being different for each rolling bearing 1.

As described above, it is possible to provide the rolling bearing 1 capable of ensuring durability and reducing rotational resistance.

Further, in the present embodiment, the grease 60 is in contact with both the inner circumferential surface of the outer ring 20 and the sealing member 50. In this configuration, after the grease 60 is applied to the outer ring 20 when the grease 60 is used to enclose a space between the outer ring 20 and the inner ring 10, the grease 60 is pressed inward in the axial direction by the sealing member 50 when the sealing member 50 is mounted on the outer ring 20. Here, in grease having relatively small unworked penetration (hard) as in the related art, when the grease is pressed inward in the axial direction by the sealing member, the entire grease may move inward in the axial direction with slight deformation, and the grease may come into contact with the rolling body 30 or the cage 40 by a desired amount or more. In the present embodiment, since the grease 60 has relatively large unworked penetration (soft), the grease 60 is also easily deformed in the radial direction when the grease 60 is pressed inward in the axial direction by the sealing member 50, and the grease 60 is prevented from moving inward in the axial direction, so that the grease 60 is prevented from coming into contact with the rolling body 30 or the cage 40 more than necessary. Therefore, an increase in rotational resistance of the rolling bearing 1 can be reduced.

The grease 60 is in contact with the outward facing surface 24a of the recessed portion 24 that is inclined outward in the axial direction with respect to the radial direction. According to this configuration, the outward facing surface 24a of the recessed portion 24 restricts the grease 60 from being displaced inward in the axial direction from the initial state. Accordingly, since the grease 60 is less likely to be displaced inward in the axial direction from an initial position in a process of repeated use of the rolling bearing 1, it is possible to increase an amount of the grease 60 to be enclosed, and it is possible to obtain the above-described operation and effect more reliably.

Further, since the grease 60 is in contact with the outward facing surface 24a of the recessed portion 24, a shape and position of the grease 60 are less likely to change due to vibration during transportation or storage for a long period (particularly, storage in a high-temperature environment). Therefore, it is possible to provide the rolling bearing 1 in which a fluctuation in the rotational resistance from an initial stage of manufacturing is reduced.

The recessed portion 24 has the inward facing surface 24b that is inclined inward in the axial direction with respect to the radial direction. According to this configuration, the inward facing surface 24b of the recessed portion 24 restricts the grease 60 from being displaced outward in the axial direction. Accordingly, it is possible to prevent the grease 60 or base oil of the grease 60 from flowing out to a sealing member 50 side and leaking from a gap between the sealing member 50 and the outer ring 20.

In particular, in the present embodiment, since the grease 60 is in contact with the outward facing surface 24a of the recessed portion 24, the grease 60 is supported by the sealing member 50 in addition to the recessed portion 24. Therefore, the shape and position of the grease 60 are less likely to change due to vibration during transportation or storage for a long period (particularly, storage in a high-temperature environment). Therefore, it is possible to provide the rolling bearing 1 in which a fluctuation in the rotational resistance from an initial stage of manufacturing is reduced.

In addition, since the grease 60 is in contact with the extension portion 52 and the planar portion 53 of the sealing member 50, an effect of reducing a change in the shape and position of the grease 60 is easily achieved. Since an amount of the grease 60 can be increased, higher durability can be provided to the rolling bearing 1. The grease 60 is in contact with at least one of the extension portion 52 and the planar portion 53 of the sealing member 50, so that the above-described effect is achieved. More preferably, the grease 60 is in contact with the planar portion 53.

The grease 60 is in contact with the sealing member 50. According to this configuration, when the sealing member 50 is mounted on the outer ring 20 in a state where the grease 60 is applied to the outer ring 20, even when the grease 60 in contact with the sealing member 50 is pressed inward in the axial direction by the sealing member 50, the grease 60 is restricted, by the recessed portion 24, from being displaced inward in the axial direction as described above. Therefore, it is possible to prevent the grease 60 from coming into contact with the rolling body 30 or the cage 40 by a desired amount or more. Therefore, the rotational resistance of the rolling bearing 1 can be reduced.

The grease 60 is also in contact with the ridge portion 25 formed at the end edge of the recessed portion 24 on the outer ring raceway surface 23 side. According to this configuration, it is not necessary for the base oil oozing from the grease 60 to go over the ridge portion 25 in a process of reaching the outer ring raceway surface 23, and an insufficient supply of the base oil of the grease 60 to the rolling body 30 can be prevented.

The grease 60 includes the outer ring contact portion 61 that is in contact with the inner circumferential surface 22b of the protruding portion 22 of the outer ring 20, and the sealing member contact portion 62 that is in contact with the planar portion 53 of the sealing member 50 on the outer side in the axial direction and the inner side in the radial direction relative to the outer ring contact portion 61. An area of the sealing member contact portion 62 is larger than a contact area of the grease 60 with the extension portion 52 and the pedestal portion 51 of the sealing member 50. According to this configuration, when the sealing member 50 is mounted after the grease 60 is applied to a predetermined location, it is possible to provide a space for the grease 60 pressed inward in the axial direction by the planar portion 53 of the sealing member 50 to spread in the radial direction toward the extension portion 52 and the pedestal portion 51. Therefore, the grease 60 can be prevented from spreading largely toward an inner ring 10 side and a rolling body 30 side. Thus, the grease 60 can be easily prevented from directly contacting the rolling body 30 and the cage 40.

In addition, since the extension portion 52 is provided between the planar portion 53 and the pedestal portion 51 in the sealing member 50, the grease 60 can be disposed at a position further away from the rolling body 30 than in a configuration in which the planar portion extends inward in the radial direction from the pedestal portion. Thus, an amount of the grease 60 can be increased.

As described above, it is possible to provide the rolling bearing 1 capable of ensuring durability and reducing rotational resistance.

The grease 60 is not in contact with the extension portion 52. According to this configuration, when the sealing member 50 is mounted, it is possible to provide a larger space for the grease 60 pressed inward in the axial direction by the planar portion 53 of the sealing member 50 to spread in the radial direction toward the extension portion 52. Therefore, the grease 60 can be prevented from spreading largely toward the inner ring 10 side and the rolling body 30 side. Thus, the grease 60 can be easily prevented from coming into contact with the rolling body 30, the cage 40, and the inner ring 10 more than necessary.

Since the difference between the worked penetration and the unworked penetration of the grease 60 is less than 50, softness of a portion of the grease 60 that is not in contact with the rolling body 30 and the cage 40 is close to softness of a portion of the grease 60 that is in contact with the rolling body 30 or the cage 40. Accordingly, a difference in a degree of oozing of the base oil between the portion of the grease 60 that is in contact with the rolling body 30 or the cage 40 and the portion of the grease 60 that is not in contact with the rolling body 30 and the cage 40 is reduced. Therefore, the rotational resistance of the rolling bearing 1 can be stabilized for a long period of time.

Since the ratio of the difference between the worked penetration and the unworked penetration to the worked penetration of the grease 60 is less than 22.7%, the softness of the portion of the grease 60 that is not in contact with the rolling body 30 and the cage 40 is close to the softness of the portion of the grease 60 that is in contact with the rolling body 30 or the cage 40. Accordingly, a difference in a degree of oozing of the base oil between the portion of the grease 60 that is in contact with the rolling body 30 or the cage 40 and the portion of the grease 60 that is not in contact with the rolling body 30 and the cage 40 is reduced. Therefore, the rotational resistance of the rolling bearing 1 can be stabilized for a long period of time.

The thickener of the grease 60 contains urea. According to this configuration, since grease having high heat resistance can be obtained, the rolling bearing 1 having low rotational resistance and high durability can be formed. In general, in the grease using urea as the thickener, the difference between the worked penetration and the unworked penetration is likely to become large, but the grease satisfying the above penetration conditions can be obtained by selecting a type of urea, mixing a plurality of types of urea, adjusting urea formation conditions, adjusting additives, and the like.

Since the unworked penetration of the grease 60 after standing at 85° C. for 18 hours is larger than 158, a degree of hardening of the grease 60 can be set to such an extent that the base oil oozes out smoothly, even when the grease 60 is exposed to a high temperature or left to stand for a long time. Therefore, the rolling bearing 1 having high durability can be formed.

According to the rotating device 2 in the present embodiment, by including the rolling bearing 1 that ensures durability and reduces rotational resistance, it is possible to achieve a long service life of the rotating device 2 and to achieve power saving of the rotating device 2 by reduction in rotational resistance of the shaft 3 with respect to the housing 4.

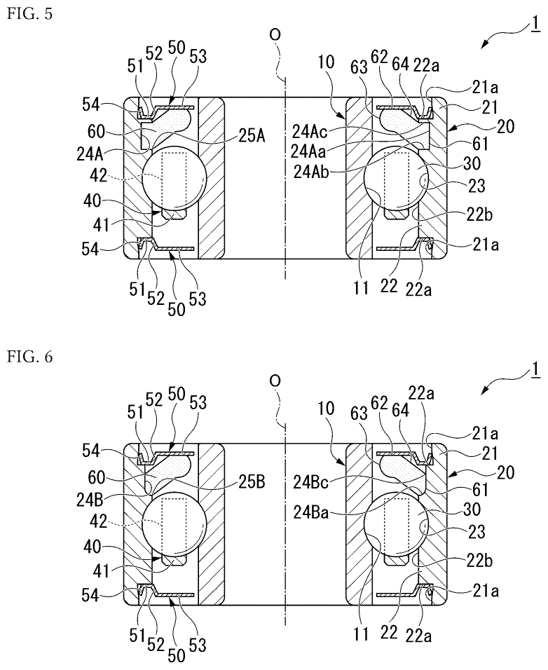

In the first embodiment, the recessed portion 24 extends in a curved shape on the longitudinal cross section of the rolling bearing 1, but the invention is not limited to this configuration. As shown in FIG. 5, a recessed portion 24A may define a rectangular space on the longitudinal cross section of the rolling bearing 1. That is, the recessed portion 24A includes a bottom surface 24Aa extending in the axial direction, a first step surface 24Ab extending inward in the radial direction from an end edge of the bottom surface 24Aa on the inner side in the axial direction and facing upward, and a second step surface 24Ac extending inward in the radial direction from an end edge of the bottom surface 24Aa on the outer side in the axial direction and facing downward. In this case, the grease 60 is restricted from being displaced inward in the axial direction from an initial state by being brought into contact with the first step surface 24Ab, and thus a similar operation and effect as those of the first embodiment are obtained, and the grease 60 is restricted from being displaced outward in the axial direction by being brought into contact with the second step surface 24Ac, and thus a similar operation and effect as those of the first embodiment are obtained. In the present modification, the grease 60 is also preferably in contact with a ridge portion 25A formed at an end edge of the recessed portion 24A on the outer ring raceway surface 23 side (inner side in the axial direction).

In the first embodiment, the recessed portion 24 opens only in the inner circumferential surface 22b, but the invention is not limited to this configuration. As shown in FIG. 6, the recessed portion 24B may be provided without an interval in the axial direction with respect to the end surface 22a facing upward, and may be open to the inner circumferential surface 22b and the end surface 22a facing upward. In the shown example, the recessed portion 24B includes an outward facing surface 24Ba facing a direction inclined outward in the axial direction with respect to the radial direction (inward and upward in the radial direction, or upward), and a cylindrical surface 24Bc facing inward in the radial direction. The grease 60 is in contact with the outward facing surface 24Ba and the cylindrical surface 24Bc. In the present modification, the grease 60 is also preferably in contact with a ridge portion 25B formed at an end edge of the recessed portion 24B on the outer ring raceway surface 23 side (inner side in the axial direction).

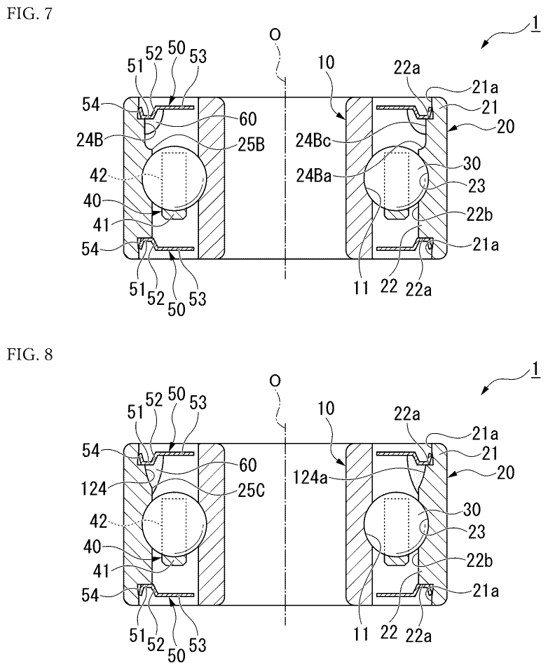

Further, as shown in FIG. 7, the grease 60 may be in contact with the sealing member 50 through an opening of the recessed portion 24B on the end surface 22a. In the shown example, the grease 60 is in contact with the pedestal portion 51 of the sealing member 50, which closes the opening of the recessed portion 24B on the end surface 22a. The grease 60 may be in contact with the extension portion 52 and the planar portion 53 in addition to the pedestal portion 51. In this case, the grease 60 may not be in contact with the ridge portion 25B or may be in contact with the ridge portion 25B. The grease 60 is in contact with only the cylindrical surface 24Bc of the recessed portion 24B. The grease 60 may be, however, in contact with the outward facing surface 24Ba in addition to the cylindrical surface 24Bc.

As shown in FIG. 8, a recessed portion 124 may be formed such that the entire recessed portion 124 faces a direction inclined outward in the axial direction with respect to the radial direction (inward and upward in the radial direction, or upward). That is, the recessed portion 124 may not have a portion extending in the axial direction. In the shown example, the recessed portion 124 has an inclined surface 124a extending from a ridge portion 25C formed at an end edge of the recessed portion 124 on the outer ring raceway surface 23 side (inner side in the axial direction) to an opening edge on the end surface 22a. The inclined surface 124a extends outward in the radial direction and outward in the axial direction from the ridge portion 25C. In the shown example, the inclined surface 124a is a recessed curved surface that continues throughout. It is sufficient that the inclined surface extends in a direction inclined with respect to the axial direction from the ridge portion 25C, and the inclined surface may be formed of a plurality of discontinuous surfaces, or may be a conical surface extending at a constant inclination angle with respect to the axial direction. Further, a portion of the inclined surface may extend along the radial direction.

In the modification shown in FIG. 8, the grease 60 is in contact with the ridge portion 25C from the inclined surface 124a. Further, in the present modification, the grease 60 is also in contact with a location of the inner circumferential surface of the protruding portion 22 of the outer ring 20 between the ridge portion 25C and the outer ring raceway surface 23. That is, the grease 60 is in contact with the inclined surface 124a from the location between the ridge portion 25C and the outer ring raceway surface 23 so as to go over the ridge portion 25C in the axial direction. With this configuration, it is not necessary for the base oil oozing from the grease 60 to go over the ridge portion 25C in a process of reaching the outer ring raceway surface 23, and an insufficient supply of the base oil of the grease 60 to the rolling body 30 can be prevented. In the present modification, as in a third modification shown in FIG. 7, the grease 60 is in contact with the sealing member 50 through an opening of the recessed portion 124 on the end surface 22a. In the present modification, the grease 60 may not be in contact with the sealing member 50.

In the first embodiment, the recessed portion 24 continuously extends throughout the circumferential direction, but the invention is not limited to this configuration. The recessed portion may be formed discontinuously in the circumferential direction so that an intermittent portion is formed in at least a portion of the circumferential direction.

In the first embodiment, the pedestal portion 51 of the sealing member 50 protrudes inward in the radial direction from the end surface 22a of the protruding portion 22 of the outer ring 20 in the plan view. However, the pedestal portion is preferably disposed so as not to protrude further inward in the radial direction than the end surface 22a of the protruding portion 22 in the plan view. According to this configuration, even when the outer ring contact portion 61 of the grease 60 spreads outward in the axial direction and goes over the inner circumferential edge of the end surface 22a, it is possible to prevent the grease 60 from adhering to the pedestal portion. Therefore, the grease 60 can be prevented from coming into contact with the contact portion between the outer ring 20 and the pedestal portion. Accordingly, it is possible to prevent the grease 60 from leaking to the outside of the sealing member through the contact portion between the outer ring 20 and the pedestal portion due to a capillary phenomenon.

In the first embodiment, the grease 60 is not in contact with the pedestal portion 51 and the extension portion 52 of the sealing member 50, but the invention is not limited to this configuration. The grease may be in contact with at least one of the pedestal portion 51 and the extension portion 52 of the sealing member 50. As long as an area of the sealing member contact portion is larger than a contact area between the grease and the extension portion 52 and the pedestal portion 51, the above-described operation and effect are obtained.

As a method for fixing the sealing member 50, in addition to a method for press-fitting and fixing the sealing member 50 to the bearing ring (outer ring 20) as in the present embodiment, there is also a method for fixing the bearing ring from the outer side in the axial direction by a stop ring such as a C-ring, but in this case, a position of the sealing member 50 is closer to the inner side in the axial direction, which is not preferable. By press-fitting and fixing the sealing member 50, the sealing member 50 can be disposed further outward in the axial direction, and an amount of the grease 60 can be increased. Since the recessed portion 24 can be provided on the outer side in the axial direction, even when the grease 60 is applied to the recessed portion 24, the grease 60 is less likely to be caught in the rolling body 30 or the raceway surface, and the rotational resistance of the rolling bearing can be reduced.

### Second Embodiment

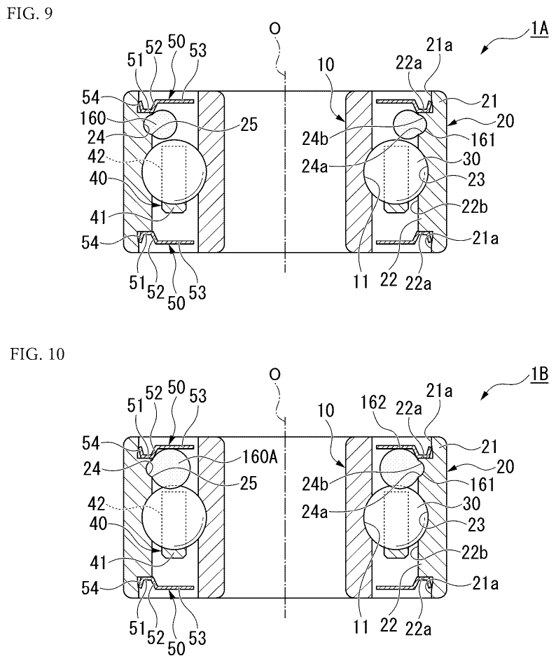

Next, a second embodiment will be described with reference to FIG. 9. The second embodiment is different from the first embodiment in that a rolling bearing 1A includes grease 160 instead of the grease 60 in the first embodiment. Configurations other than those to be described below are similar as those of the first embodiment.

FIG. 9 is a longitudinal cross-sectional view of the rolling bearing according to the second embodiment.

As shown in FIG. 9, the grease 160 is disposed along the circumferential direction. The grease 160 extends in an annular shape and is disposed coaxially with the common axis O. The grease 160 includes an outer ring contact portion 161 that is in contact with the inner circumferential surface 22b of the protruding portion 22 of the outer ring 20, and is not in contact with the inner ring 10, the sealing member 50, the rolling body 30, and the cage 40. The outer ring contact portion 161 extends in the circumferential direction over an entire length of the grease 160. The outer ring contact portion 161 has a width in the axial direction throughout the circumferential direction. The outer ring contact portion 161 is in contact with the recessed portion 24 of the inner circumferential surface 22b of the protruding portion 22. The grease 160 is preferably in contact with at least a part of the ridge portion 25. In the present embodiment, the outer ring contact portion 161 is in contact with the ridge portion 25 over the entire circumference. The outer ring contact portion 161 is provided with an interval in the axial direction with respect to the contact portion between the outer ring 20 and the pedestal portion 51 of the sealing member 50.

In the present embodiment, a similar effect as that of the first embodiment is achieved. In addition, in the present embodiment, since the grease 160 is not in contact with the sealing member 50, the grease 160 is not pressed by the sealing member 50 when the sealing member 50 is mounted on the outer ring 20. Accordingly, it is possible to prevent the grease 160 from moving inward in the axial direction and to prevent the grease 160 from coming into contact with the rolling body 30 or the cage 40 more than necessary. Therefore, an increase in rotational resistance of the rolling bearing 1A can be reduced.

In the second embodiment, the grease 160 extends in an annular shape, but the invention is not limited to this configuration. The grease may extend in an arc shape so as to form an intermittent portion, or may include a plurality of particles disposed in a dot shape over an entire circumference. When the grease has a plurality of particles, the plurality of particles aligned in the circumferential direction may be integrated or separated from each other.

### Third Embodiment

Next, a third embodiment will be described with reference to FIG. 10. A rolling bearing 1B according to the third embodiment is different from the rolling bearing 1A according to the second embodiment in that grease 160A is in contact with the sealing member 50 and the rolling body 30. Configurations other than those to be described below are similar as those of the second embodiment.

FIG. 10 is a longitudinal cross-sectional view of the rolling bearing according to the third embodiment.

As shown in FIG. 10, the grease 160A further includes a sealing member contact portion 162 that is in contact with the planar portion 53 of the sealing member 50 on the outer side in the axial direction and the inner side in the radial direction relative to the outer ring contact portion 161, and is not in contact with the inner ring 10. The sealing member contact portion 162 is in contact with only the planar portion 53 of the sealing member 50. Accordingly, the grease 160A does not come into contact with the pedestal portion 51 and the extension portion 52 of the sealing member 50 located closer to an outer ring 20 side than the planar portion 53. The grease 160A is in contact with the rolling body 30. A volume of a portion of the grease 160A that is in contact with the rolling body 30 is half or less of a volume of the entire grease 160A. The grease 160A may be in contact with the cage 40.

In the present embodiment, a similar effect as that of the second embodiment is achieved. In addition, in the present embodiment, since the grease 160A is in contact with the rolling body 30, base oil of the grease 160A can be directly supplied to the rolling body 30. Therefore, an increase in rotational resistance of the rolling bearing 1B can be reduced.

In the third embodiment, as in the first embodiment, the grease 160A is prevented from spreading largely toward the inner ring 10 side and the rolling body 30 side when the sealing member 50 is mounted. Therefore, even when the grease 160A is in contact with the rolling body 30, a contact portion can be sufficiently reduced compared with a structure in the related art, and an effect of reducing the rotational resistance can be obtained.

In the third embodiment, the grease 160A extends in an annular shape, but the invention is not limited to this configuration. The grease may extend in an arc shape so as to form an intermittent portion, or may include a plurality of particles disposed in a dot shape over an entire circumference. When the grease has a plurality of particles, the plurality of particles aligned in the circumferential direction may be integrated or separated from each other.

### Fourth Embodiment

Next, a fourth embodiment will be described.

Grease is in contact with only a portion that is a portion of a recessed portion, faces a direction inclined outward in the axial direction with respect to the radial direction (inward and upward in the radial direction, or upward), and is continuous with a ridge portion. For example, when the recessed portion has a bottom surface extending in the axial direction, the grease is in contact with only a portion between the ridge portion and the bottom surface with respect to the recessed portion. The grease is preferably in contact with the sealing member. Accordingly, the grease is sandwiched from both sides in the axial direction by the sealing member and the recessed portion, and an initial shape can be maintained for a long period of time.

### Fifth Embodiment

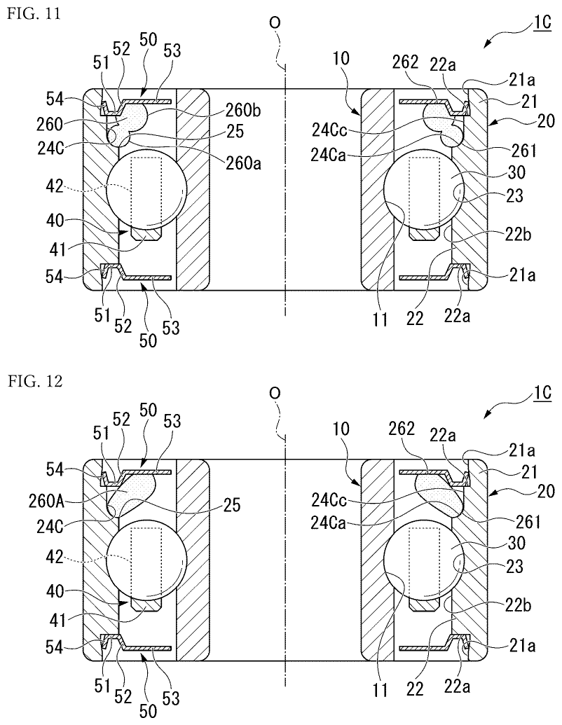

Next, a fifth embodiment will be described with reference to FIG. 11. A rolling bearing 1C according to the fifth embodiment is different from the rolling bearing 1 according to the first embodiment in that grease 260 is in contact with only an outward facing surface 24Ca of a recessed portion 24C. Configurations other than those to be described below are similar as those of the first embodiment.

FIG. 11 is a longitudinal cross-sectional view of the rolling bearing according to the fifth embodiment.

As shown in FIG. 11, the recessed portion 24C recessed outward in the radial direction is formed in the inner circumferential surface 22b of the protruding portion 22 of the outer ring 20. The recessed portion 24C is provided without an interval in the axial direction with respect to the end surface 22a of the protruding portion 22 facing upward, and is open to the inner circumferential surface 22b and the end surface 22a facing upward. The recessed portion 24C includes the outward facing surface 24Ca facing a direction inclined outward in the axial direction with respect to the radial direction (inward and upward in the radial direction, or upward), and a cylindrical surface 24Cc facing inward in the radial direction. The outward facing surface 24Ca is a recessed curved surface. The cylindrical surface 24Cc extends in the axial direction and is smoothly connected to the outward facing surface 24Ca at an end edge on the inner side in the axial direction such that a tangent line with respect to the outward facing surface 24Ca is continuous.

The grease 260 includes an outer ring contact portion 261 (bearing ring contact portion) that is in contact with the inner circumferential surface 22b of the protruding portion 22 of the outer ring 20, and a sealing member contact portion 262 that is in contact with the sealing member 50 on the outer side in the axial direction and the inner side in the radial direction relative to the outer ring contact portion 261. The outer ring contact portion 261 is in contact with the recessed portion 24C of the inner circumferential surface 22b of the protruding portion 22. The outer ring contact portion 261 is in contact with the recessed portion 24C over an entire circumference. The outer ring contact portion 261 is in contact with only the outward facing surface 24Ca of the recessed portion 24C. In this case, the outer ring contact portion 261 is preferably in contact with at least a part of the ridge portion 25 of the inner circumferential surface 22b. The outer ring contact portion 261 may not be in contact with the ridge portion 25 of the inner circumferential surface 22b. In the present embodiment, the sealing member contact portion 262 is a location of the grease 260 that is in contact with the planar portion 53 of the sealing member 50. In the present embodiment, the grease 260 is also in contact with the pedestal portion 51 and the extension portion 52 of the sealing member 50. When the grease 260 is in contact with at least one of the pedestal portion 51 and the extension portion 52 of the sealing member 50, an area of the sealing member contact portion 262 is preferably larger than a contact area between the grease 260 and the extension portion 52 and the pedestal portion 51. The grease 260 may be in non-contact with at least one of the pedestal portion 51 and the extension portion 52. The grease 260 is formed such that a cross-sectional area of a cross section along a vertical plane of the common axis O gradually increases from an end portion on the outer side in the axial direction toward the inner side in the axial direction.

The grease 260 includes a first annular portion 260a that is in contact with the outer ring 20 and a second annular portion 260b that is continuous with the first annular portion 260a and in contact with the sealing member 50. The first annular portion 260a and the second annular portion 260b are formed by applying grease twice. The first annular portion 260a and the second annular portion 260b extend in a circumferential shape around the common axis O. At least one of the first annular portion 260a and the second annular portion 260b may extend less than 360° about the common axis O. The first annular portion 260a includes the outer ring contact portion 261. The second annular portion 260b is disposed on an opposite side of the outer ring 20 in the radial direction (that is, on the inner side in the radial direction) with respect to the first annular portion 260a. The second annular portion 260b is integrally connected to the first annular portion 260a on the outer side in the axial direction. The second annular portion 260b includes the sealing member contact portion 262.

In the present embodiment, a similar effect as that of the first embodiment is achieved. In addition, in the present embodiment, the recessed portion 24C opens to the end surface 22a of the protruding portion 22 facing upward, and the grease 260 is in contact with only the outward facing surface 24Ca of the recessed portion 24C. With this configuration, it is possible to prevent the grease 260 or base oil of the grease 260 from flowing out from the recessed portion 24C to the end surface 22a side and leaking from the gap between the end surface 22a and the pedestal portion 51 of the sealing member 50.

In the fifth embodiment, the first annular portion 260a and the second annular portion 260b extend in the circumferential shape, but the invention is not limited to this configuration. At least one of the first annular portion and the second annular portion may include particles disposed in a dot shape over an entire circumference. In this case, the plurality of particles aligned in the circumferential direction may be integrated or separated from each other.

In the fifth embodiment, the grease 260 includes the first annular portion 260a and the second annular portion 260b, but the invention is not limited to this configuration. As shown in FIG. 12, grease 260A may be formed of a single annular portion having the outer ring contact portion 261 and the sealing member contact portion 262.

### Sixth Embodiment

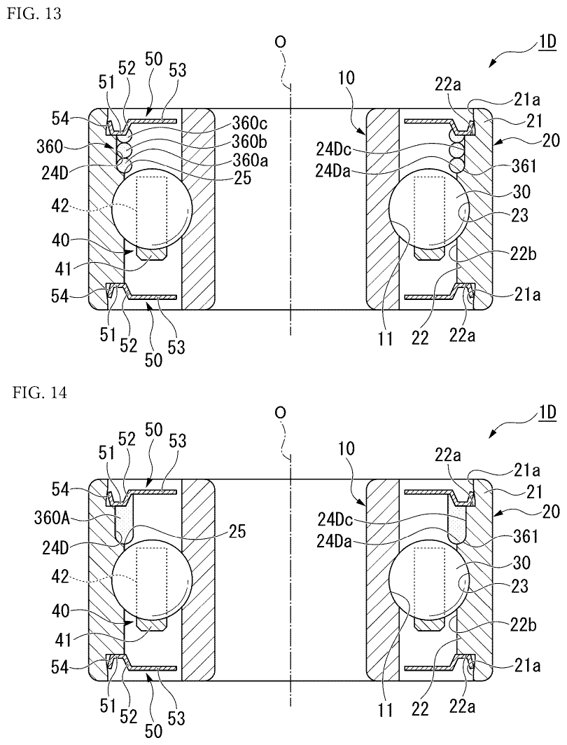

Next, a sixth embodiment will be described with reference to FIG. 13. A rolling bearing 1D according to the sixth embodiment is different from the rolling bearing 1 according to the first embodiment in that grease 360 is disposed in the axial direction along a recessed portion 24D. Configurations other than those to be described below are similar as those of the first embodiment.

FIG. 13 is a longitudinal cross-sectional view of the rolling bearing according to the sixth embodiment.

As shown in FIG. 13, the recessed portion 24D recessed outward in the radial direction is formed in the inner circumferential surface 22b of the protruding portion 22 of the outer ring 20. The recessed portion 24D is provided without an interval in the axial direction with respect to the end surface 22a of the protruding portion 22 facing upward, and is open to the inner circumferential surface 22b and the end surface 22a facing upward. The recessed portion 24D includes an outward facing surface 24Da facing a direction inclined outward in the axial direction with respect to the radial direction (inward and upward in the radial direction, or upward), and a cylindrical surface 24Dc facing inward in the radial direction. The outward facing surface 24Da is a recessed curved surface. The cylindrical surface 24Dc extends in the axial direction and is smoothly connected to the outward facing surface 24Da at an end edge on the inner side in the axial direction such that a tangent line with respect to the outward facing surface 24Da is continuous. The recessed portion 24D extends in the axial direction such that a width in the axial direction is larger than a depth in the radial direction on a longitudinal cross section of the rolling bearing 1D. The outward facing surface may be a flat surface facing outward in the axial direction or a conical surface facing outward in the axial direction and inward in the radial direction.

The grease 360 includes an outer ring contact portion 361 that is in contact with the inner circumferential surface 22b of the protruding portion 22 of the outer ring 20. The outer ring contact portion 361 is in contact with the recessed portion 24D of the inner circumferential surface 22b of the protruding portion 22. The outer ring contact portion 361 is in contact with the recessed portion 24D over an entire circumference. The outer ring contact portion 361 is in contact with the outward facing surface 24Da and the cylindrical surface 24Dc of the recessed portion 24D. The outer ring contact portion 361 is in contact with at least a part of the ridge portion 25 of the inner circumferential surface 22b. The grease 360 is in contact with the sealing member 50. In the present embodiment, the grease 360 is in contact with the pedestal portion 51 and the extension portion 52 of the sealing member 50.

The grease 360 is disposed in the axial direction along the recessed portion 24D on the longitudinal cross section of the rolling bearing 1D. The grease 360 includes a first annular portion 360a, a second annular portion 360b, and a third annular portion 360c disposed in the axial direction. The first annular portion 360a, the second annular portion 360b, and the third annular portion 360c are formed by applying grease three times. The first annular portion 360a, the second annular portion 360b, and the third annular portion 360c extend in a circumferential shape around the common axis O. At least one of the first annular portion 360a, the second annular portion 360b, and the third annular portion 360c may extend less than 360° about the common axis O. The first annular portion 360a is in contact with the outward facing surface 24Da and the cylindrical surface 24Dc of the recessed portion 24D. The second annular portion 360b is continuous with the first annular portion 360a on the outer side in the axial direction. The second annular portion 360b is in contact with the cylindrical surface 24Dc of the recessed portion 24D. The third annular portion 360c is continuous with the second annular portion 360b on the outer side in the axial direction. The third annular portion 360c is in contact with the cylindrical surface 24Dc of the recessed portion 24D and the sealing member 50.

In the present embodiment, a similar effect as that of the first embodiment is achieved. In addition, in the present embodiment, since the grease 360 is disposed in the axial direction along the recessed portion 24D, it is possible to effectively restrict, by the recessed portion 24D, the grease 360 from being displaced in the axial direction, and it is possible to prevent the grease 360 from being displaced and coming into contact with the rolling body 30 or the cage 40 by a desired amount or more. Further, a shape and position of the grease 360 are less likely to change due to vibration during transportation or storage for a long period (particularly, storage in a high-temperature environment). Therefore, it is possible to provide the rolling bearing 1D in which a fluctuation in the rotational resistance from an initial stage of manufacturing is reduced.

In the sixth embodiment, the first annular portion 360a, the second annular portion 360b, and the third annular portion 360c extend in the circumferential shape, but the invention is not limited to this configuration. At least one of the first annular portion, the second annular portion, and the third annular portion may include particles disposed in a dot shape over an entire circumference. In this case, the plurality of particles aligned in the circumferential direction may be integrated or separated from each other.

In the sixth embodiment, the grease 360 includes the first annular portion 360a, the second annular portion 360b, and the third annular portion 360c, but the invention is not limited to this configuration. As shown in FIG. 14, grease 360A may extend in the axial direction along the recessed portion 24D on the longitudinal cross section of the rolling bearing 1D.

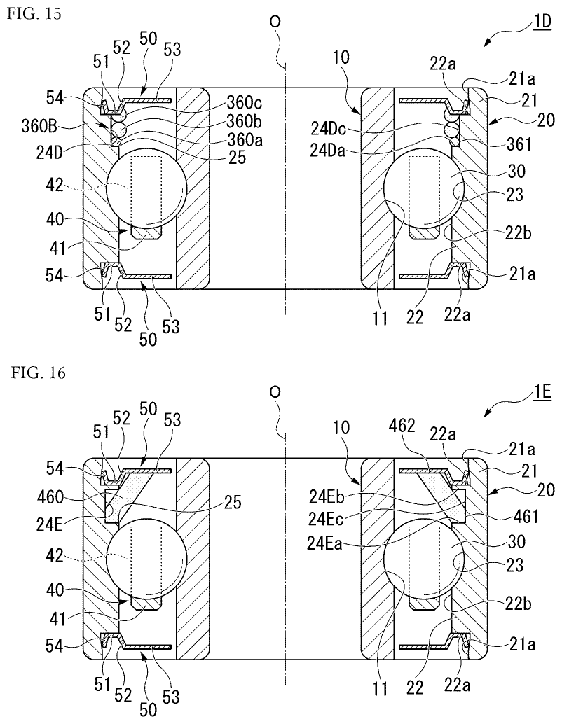

In the sixth embodiment, the grease 360 is in contact with the ridge portion 25 of the inner circumferential surface 22b of the protruding portion 22 of the outer ring 20, but the invention is not limited to this configuration. As shown in FIG. 15, grease 360B may not be in contact with the ridge portion 25. In this case, the first annular portion 360a may be formed smaller than the second annular portion 360b and the third annular portion 360c on the longitudinal cross section of the rolling bearing 1D so as not to contact the ridge portion 25. According to this configuration, in exchange for an insufficient supply of base oil of the grease 360B to the rolling body 30, a total amount of the grease 360B can be increased to provide higher durability to the rolling bearing 1D.

### Seventh Embodiment

Next, a seventh embodiment will be described with reference to FIG. 16. A rolling bearing 1E according to the seventh embodiment is different from the rolling bearing 1 according to the first embodiment in that the deepest location of the recessed portion 24E in the radial direction is formed on the inner side in the axial direction relative to an intermediate position of the recessed portion 24E in the axial direction. Configurations other than those to be described below are similar as those of the first embodiment.

FIG. 16 is a longitudinal cross-sectional view of the rolling bearing according to the seventh embodiment.

As shown in FIG. 16, the recessed portion 24E is provided with an interval in the axial direction with respect to the outer ring raceway surface 23. The recessed portion 24E is provided with an interval in the axial direction with respect to the end surface 22a facing upward. The recessed portion 24E is formed such that a width in the axial direction is larger than a depth in the radial direction on a longitudinal cross section of the rolling bearing 1E. The recessed portion 24E includes an outward facing surface 24Ea facing a direction inclined outward in the axial direction with respect to the radial direction (inward and upward in the radial direction, or upward), an inward facing surface 24Eb facing a direction inclined inward in the axial direction with respect to the radial direction (inward and downward in the radial direction, or downward), and a cylindrical surface 24Ec facing inward in the radial direction. In the present embodiment, the outward facing surface 24Ea and the inward facing surface 24Eb face the axial direction. Accordingly, the recessed portion 24E is formed in a rectangular shape on the longitudinal cross section of the rolling bearing 1E. The cylindrical surface 24Ec is located at the deepest position of the recessed portion 24E in the radial direction, and extends over, in the axial direction, the intermediate position in the recessed portion 24E in the axial direction. Accordingly, the deepest location of the recessed portion 24E in the radial direction is formed on the inner side in the axial direction relative to the intermediate position of the recessed portion 24E in the axial direction.

The grease 460 includes an outer ring contact portion 461 (bearing ring contact portion) that is in contact with the inner circumferential surface 22b of the protruding portion 22 of the outer ring 20, and a sealing member contact portion 462 that is in contact with the planar portion 53 of the sealing member 50 on the outer side in the axial direction and the inner side in the radial direction relative to the outer ring contact portion 461. The outer ring contact portion 461 is in contact with the recessed portion 24E of the inner circumferential surface 22b of the protruding portion 22. The outer ring contact portion 461 is in contact with the recessed portion 24E over an entire circumference. The outer ring contact portion 461 is in contact with the outward facing surface 24Ea and the cylindrical surface 24Ec of the recessed portion 24E. The outer ring contact portion 461 is in contact with at least a part of the ridge portion 25 of the inner circumferential surface 22b. The grease 460 is not in contact with the inward facing surface 24Eb of the recessed portion 24E. The grease 460 may be in contact with the inward facing surface 24Eb of the recessed portion 24E. In the present embodiment, the sealing member contact portion 462 is a location of the grease 460 that is in contact with the planar portion 53 of the sealing member 50. In the present embodiment, the grease 460 is not in contact with the pedestal portion 51 and the extension portion 52 of the sealing member 50. The grease 460 may be in contact with at least one of the pedestal portion 51 and the extension portion 52 of the sealing member 50. In this case, an area of the sealing member contact portion 462 is preferably larger than a contact area between the grease 260 and the extension portion 52 and the pedestal portion 51. The grease 460 extends outward in the axial direction and inward in the radial direction from the outer ring contact portion 461 toward the sealing member contact portion 462.

In the present embodiment, a similar effect as that of the first embodiment is achieved. In addition, in the present embodiment, the deepest location of the recessed portion 24E in the radial direction is formed on the inner side in the axial direction relative to the intermediate position of the recessed portion 24E in the axial direction. According to this configuration, when the grease 460 is discharged from a nozzle and applied to a predetermined location, a tip end of the nozzle is easily inserted into the outer ring 20 and the inner ring 10 from an outside of the rolling bearing 1E and brought close to the recessed portion 24E. Thus, it is possible to improve productivity of the small-diameter rolling bearing 1E. Since the nozzle can be easily brought close to the recessed portion 24E, the grease 460 can be accurately applied, and it is possible to prevent the grease 460 from coming into contact with the rolling body 30 or the like by a desired amount or more. Thus, rotational resistance of the rolling bearing 1E can be reduced.

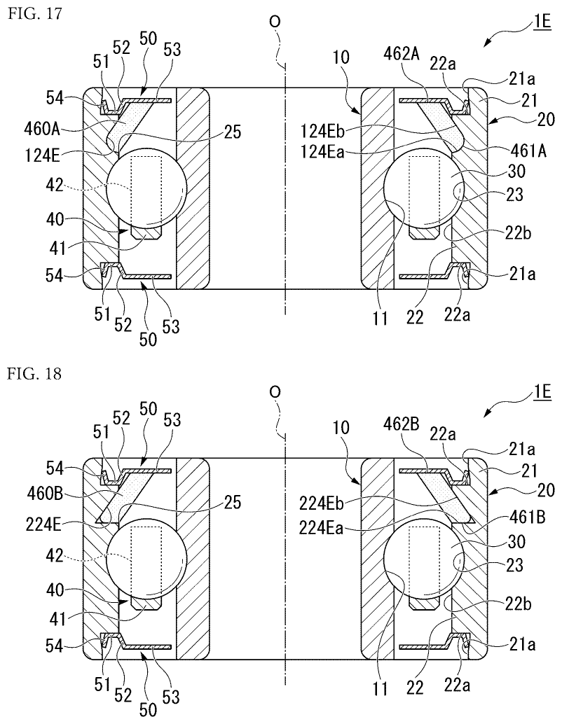

In the seventh embodiment, the recessed portion 24E is formed symmetrically in an upper-lower direction on the longitudinal cross section of the rolling bearing 1E, but the invention is not limited to this configuration. As shown in FIGS. 17 and 18, recessed portions 124E and 224E may be formed non-symmetrically in the upper-lower direction on the longitudinal cross section of the rolling bearing 1E. Hereinafter, modifications shown in FIGS. 17 and 18 will be described.

In a first modification shown in FIG. 17, a recessed portion 124E is formed such that a width in the axial direction is larger than a depth in the radial direction on the longitudinal cross section of the rolling bearing 1E. The recessed portion 124E includes an outward facing surface 124Ea facing a direction inclined outward in the axial direction with respect to the radial direction (inward and upward in the radial direction, or upward), and an inward facing surface 124Eb facing a direction inclined inward in the axial direction with respect to the radial direction (inward and downward in the radial direction, or downward). The outward facing surface 124Ea is a curved surface recessed inward in the axial direction and outward in the radial direction. The inward facing surface 124Eb is a conical surface extending outward in the axial direction and inward in the radial direction from an end edge of the outward facing surface 124Ea on the outer side in the axial direction. A connection portion between the outward facing surface 124Ea and the inward facing surface 124Eb is disposed on the inner side in the axial direction relative to an intermediate position of the recessed portion 124E in the axial direction. Accordingly, the deepest location of the recessed portion 124E in the radial direction is formed on the inner side in the axial direction relative to the intermediate position of the recessed portion 124E in the axial direction.

The grease 460A includes an outer ring contact portion 461A (bearing ring contact portion) that is in contact with the inner circumferential surface 22b of the protruding portion 22 of the outer ring 20, and a sealing member contact portion 462A that is in contact with the planar portion 53 of the sealing member 50 on the outer side in the axial direction and the inner side in the radial direction relative to the outer ring contact portion 461A. The outer ring contact portion 461A is in contact with the recessed portion 124E of the inner circumferential surface 22b of the protruding portion 22. The outer ring contact portion 461A is in contact with the recessed portion 124E over an entire circumference. The outer ring contact portion 461A is in contact with the outward facing surface 124Ea of the recessed portion 124E. The outer ring contact portion 461A is in contact with the inward facing surface 124Eb of the recessed portion 124E. The outer ring contact portion 461A is in contact with the connection portion between the outward facing surface 124Ea and the inward facing surface 124Eb of the recessed portion 124E. The grease 460A is not in contact with the ridge portion 25 of the inner circumferential surface 22b. The grease 460A may be in contact with the ridge portion 25 of the inner circumferential surface 22b.

In the present modification, the sealing member contact portion 462A is a location of the grease 460A that is in contact with the planar portion 53 of the sealing member 50. In the present modification, the grease 460A is not in contact with the pedestal portion 51 and the extension portion 52 of the sealing member 50. The grease 460A may be in contact with at least one of the pedestal portion 51 and the extension portion 52 of the sealing member 50. In this case, an area of the sealing member contact portion 462A is preferably larger than a contact area between the grease 460A and the extension portion 52 and the pedestal portion 51. The grease 460A may be formed such that a cross-sectional area of a cross section along a vertical plane of the common axis O gradually increases from an end portion on the outer side in the axial direction toward the inner side in the axial direction. The grease 460A extends outward in the axial direction and inward in the radial direction from the outer ring contact portion 461A toward the sealing member contact portion 462A. The grease 460A extends from the outer ring contact portion 461A along the inward facing surface 124Eb of the recessed portion 124E.

In a second modification shown in FIG. 18, a recessed portion 224E is formed such that a width in the axial direction is larger than a depth in the radial direction on the longitudinal cross section of the rolling bearing 1E. The recessed portion 224E includes an outward facing surface 224Ea facing a direction inclined outward in the axial direction with respect to the radial direction (inward and upward in the radial direction, or upward), and an inward facing surface 224Eb facing a direction inclined inward in the axial direction with respect to the radial direction (inward and downward in the radial direction, or downward). The outward facing surface 224Ea is a plane facing outward in the axial direction. The inward facing surface 224Eb is a conical surface extending outward in the axial direction and inward in the radial direction from an end edge of the outward facing surface 224Ea on the outer side in the radial direction. A connection portion between the outward facing surface 224Ea and the inward facing surface 224Eb is disposed inward in the axial direction of an intermediate position of the recessed portion 224E in the axial direction. Accordingly, the deepest location of the recessed portion 224E in the radial direction is formed on the inner side in the axial direction relative to the intermediate position of the recessed portion 224E in the axial direction.

The grease 460B includes an outer ring contact portion 461B (bearing ring contact portion) that is in contact with the inner circumferential surface 22b of the protruding portion 22 of the outer ring 20, and a sealing member contact portion 462B that is in contact with the planar portion 53 of the sealing member 50 on the outer side in the axial direction and the inner side in the radial direction relative to the outer ring contact portion 461B. The outer ring contact portion 461B is in contact with the recessed portion 224E of the inner circumferential surface 22b of the protruding portion 22. The outer ring contact portion 461B is in contact with the recessed portion 224E over an entire circumference. The outer ring contact portion 461B is in contact with the outward facing surface 224Ea of the recessed portion 224E. The outer ring contact portion 461B is in contact with the inward facing surface 224Eb of the recessed portion 224E. The outer ring contact portion 461B is not in contact with a connection portion between the outward facing surface 224Ea and the inward facing surface 224Eb of the recessed portion 224E. The grease 460B is not in contact with the ridge portion 25 of the inner circumferential surface 22b. The grease 460B may be in contact with the ridge portion 25 of the inner circumferential surface 22b.

In the present modification, the sealing member contact portion 462B is a location of the grease 460B that is in contact with the planar portion 53 of the sealing member 50. In the present modification, the grease 460B is not in contact with the pedestal portion 51 and the extension portion 52 of the sealing member 50. The grease 460B may be in contact with at least one of the pedestal portion 51 and the extension portion 52 of the sealing member 50. In this case, an area of the sealing member contact portion 462B is preferably larger than a contact area between the grease 460B and the extension portion 52 and the pedestal portion 51. The grease 460B may be formed such that a cross-sectional area of a cross section along a vertical plane of the common axis O gradually increases from an end portion on the outer side in the axial direction toward the inner side in the axial direction. The grease 460B extends outward in the axial direction and inward in the radial direction from the outer ring contact portion 461B toward the sealing member contact portion 462B. The grease 460B extends from the outer ring contact portion 461B along the inward facing surface 224Eb of the recessed portion 224E.

The rolling bearing 1E according to these modifications also achieves a similar effect as those of the seventh embodiment.

### Eighth Embodiment

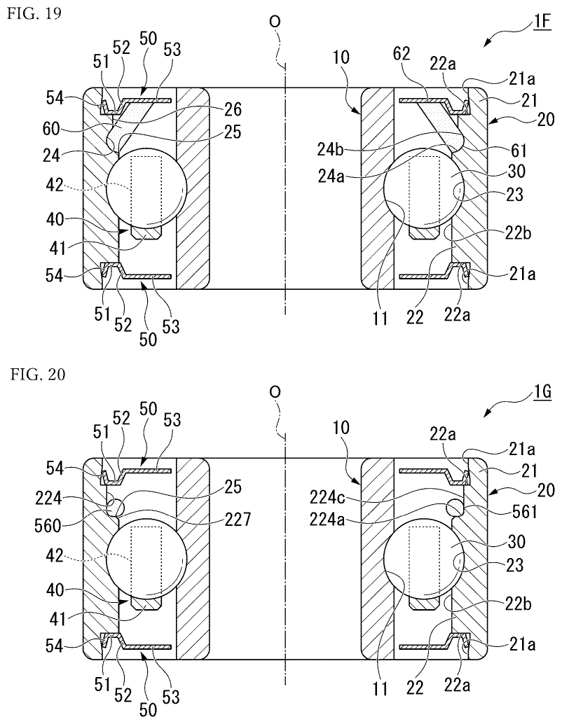

Next, an eighth embodiment will be described with reference to FIG. 19. A rolling bearing 1F according to the eighth embodiment is different from the rolling bearing 1 according to the first embodiment in a shape of the inner circumferential surface 22b of the protruding portion 22 of the outer ring 20. Configurations other than those to be described below are similar as those of the first embodiment.

FIG. 19 is a longitudinal cross-sectional view of the rolling bearing according to the eighth embodiment.

As shown in FIG. 19, the inner circumferential surface 22b of the protruding portion 22 of the outer ring 20 includes the recessed portion 24 and a connection surface 26. The recessed portion 24 is provided with an interval in the axial direction with respect to the end surface 22a of the protruding portion 22 facing upward. The connection surface 26 is formed between the recessed portion 24 and the end surface 22a of the protruding portion 22 facing upward. The connection surface 26 extends in the axial direction and faces inward in the radial direction. The connection surface 26 is located outward in the radial direction so as to be further away from the inner ring 10 in the radial direction than an end edge of the outer ring raceway surface 23 in the axial direction.

In the present embodiment, a similar effect as that of the first embodiment is achieved. In addition, in the present embodiment, the inner circumferential surface 22b of the protruding portion 22 of the outer ring 20 has the connection surface 26 formed between the recessed portion 24 and the end surface 22a. The connection surface 26 is located on the outer side in the radial direction relative to the end edge in the axial direction of the outer ring raceway surface 23 in the radial direction. According to this configuration, since the grease 60 is discharged from a nozzle and applied to a predetermined location, when a tip end of the nozzle is inserted into the outer ring 20 and the inner ring 10 from an outside of the rolling bearing 1F, it is possible to make the connection surface 26 less likely to come into contact with the nozzle. Therefore, the nozzle can be easily brought close to the recessed portion 24 when the grease 60 is applied, and productivity of the small-diameter rolling bearing 1F can be improved. Since the nozzle can be easily brought close to the recessed portion 24, the grease 60 can be accurately applied, and it is possible to prevent the grease 60 from coming into contact with the rolling body 30 or the like by a desired amount or more. Thus, rotational resistance of the rolling bearing 1F can be reduced.

### Ninth Embodiment

Next, a ninth embodiment will be described with reference to FIG. 20. A rolling bearing 1G according to the ninth embodiment is different from the rolling bearing 1 according to the first embodiment in a shape of the inner circumferential surface 22b of the protruding portion 22 of the outer ring 20. Configurations other than those to be described below are similar as those of the first embodiment.

FIG. 20 is a longitudinal cross-sectional view of the rolling bearing according to the ninth embodiment.

As shown in FIG. 20, the inner circumferential surface 22b of the protruding portion 22 of the outer ring 20 includes a recessed portion 224 and an inclined portion 227. The recessed portion 224 is provided without an interval in the axial direction with respect to the end surface 22a of the protruding portion 22 facing upward, and is open to the inner circumferential surface 22b and the end surface 22a facing upward. The recessed portion 224 includes an outward facing surface 224a facing a direction inclined outward in the axial direction with respect to the radial direction (inward and upward in the radial direction, or upward), and a cylindrical surface 224c facing inward in the radial direction. The outward facing surface 224a is a recessed curved surface. An end edge of the outward facing surface 224a on the inner side in the radial direction is located on the outer side in the radial direction relative to the end edge in the axial direction of the outer ring raceway surface 23 in the radial direction. The cylindrical surface 224c extends in the axial direction and is connected to an end edge of the outward facing surface 224a on the outer side in the axial direction. The inclined portion 227 extends from an end edge of the recessed portion 224 on the outer ring raceway surface 23 side (an end edge of the outward facing surface 224a on the inner side in the radial direction) toward the outer ring raceway surface 23 side while being inclined with respect to the radial direction and the axial direction. That is, the inclined portion 227 extends inward in the radial direction and inward in the axial direction from the ridge portion 25 of the inner circumferential surface 22b. In the present embodiment, the inclined portion 227 extends linearly from the end edge of the recessed portion 224 on a longitudinal cross section of the rolling bearing 1G. The inclined portion may extend at a steeper inclination with respect to the radial direction than the recessed portion 224 with a connection portion between the inclined portion and the recessed portion 224 as a boundary on the longitudinal cross section of the rolling bearing 1G. The inclined portion 227 is provided with an interval in the axial direction with respect to the outer ring raceway surface 23.

Grease 560 includes an outer ring contact portion 561 that is in contact with the inner circumferential surface 22b of the protruding portion 22 of the outer ring 20. The outer ring contact portion 561 is in contact with the recessed portion 224 of the inner circumferential surface 22b of the protruding portion 22. The outer ring contact portion 561 is in contact with the recessed portion 224 over an entire circumference. The outer ring contact portion 561 is in contact with the outward facing surface 224a and the cylindrical surface 224c of the recessed portion 224. The outer ring contact portion 561 is in contact with at least a part of the ridge portion 25 of the inner circumferential surface 22b. The outer ring contact portion 561 is preferably not in contact with the inclined portion 227. The grease 560 may be in contact with the sealing member 50.

In the present embodiment, a similar effect as that of the first embodiment is achieved. In addition, in the present embodiment, the inner circumferential surface 22b of the protruding portion 22 of the outer ring 20 includes the inclined portion 227 extending from the end edge of the recessed portion 224 on the outer ring raceway surface 23 side toward the outer ring raceway surface 23 side while being inclined with respect to the radial direction and the axial direction. According to this configuration, even when an end portion of the recessed portion 224 on the outer ring raceway surface 23 side extends along the radial direction, the inner circumferential surface 22b is gradually inclined from the recessed portion 224 toward the outer ring raceway surface 23. Therefore, it is possible to promote flow of base oil oozing from the grease 560 from the recessed portion 224 along the inclined portion 227 toward the outer ring raceway surface 23. Therefore, even when the grease 560 is not disposed close to the outer ring raceway surface 23, an insufficient supply of the base oil of the grease 560 to the rolling body 30 can be prevented.

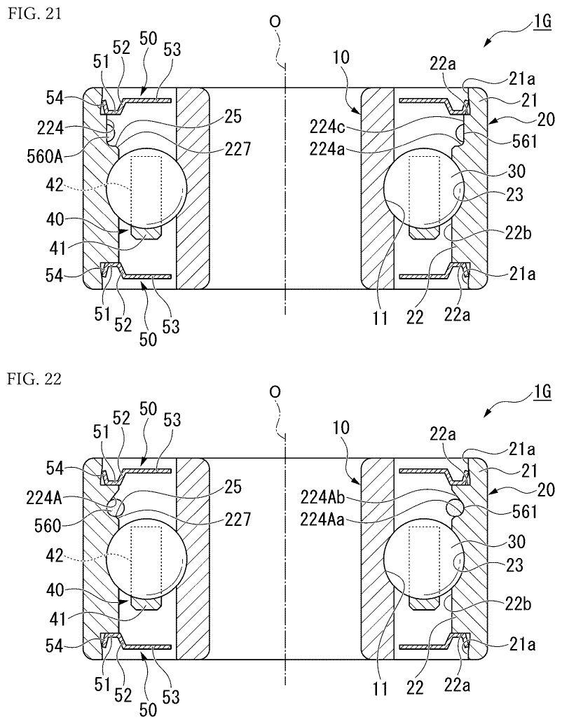

As shown in FIG. 21, grease 560A may be disposed so as not to protrude from an inner side of the recessed portion 224 to an inclined portion 227 side (inner side) in the radial direction. That is, the grease 560A may not be located within a formation range of the inclined portion 227 in the radial direction. With this configuration, the grease 560A can be prevented from coming into contact with the rolling body 30. On the other hand, by reducing an amount of the grease 560A applied, it is possible to suitably obtain an effect of preventing an insufficient supply of base oil of the grease 560A to the rolling body 30 as described above.

In the ninth embodiment, the recessed portion 224 is provided without an interval in the axial direction with respect to the end surface 22a of the protruding portion 22 facing upward, but the invention is not limited to this configuration. That is, as shown in FIG. 22, the recessed portion 224A may be provided with an interval in the axial direction with respect to the end surface 22a facing upward. In the shown example, the recessed portion 224A includes an outward facing surface 224Aa facing a direction inclined outward in the axial direction with respect to the radial direction and an inward facing surface 224Ab facing a direction inclined inward in the axial direction with respect to the radial direction, but a shape of the recessed portion is not particularly limited.

### EXAMPLE

Hereinafter, the invention will be described in detail with reference to Examples, but the invention is not limited by the following description.

A viscosity of grease in the present example was measured at 40° C. in accordance with JIS K2283. Penetration of the grease in the present example was measured by a method defined in JIS K2220.

Grease in Examples 1 to 5 and Comparative Examples 1 to 4 was prepared as follows.

### Example 1

Ester oil and a PAO were mixed at a mass ratio (ester oil/PAO)>1 to obtain base oil having a kinematic viscosity of 44 mm2/s. Alicyclic urea was synthesized in the base oil as a thickener to obtain grease having worked penetration of 228, unworked penetration of 227, and unworked penetration of 188 after standing at a high temperature.

### Example 2

The same base oil and thickener as in Example 1 were used, and a ratio of the thickener to the base oil was adjusted to obtain grease having worked penetration of 261, unworked penetration of 255, and unworked penetration of 210 after standing at a high temperature.

### Example 3

Ether oil and ester oil were mixed at a mass ratio (ether oil/ester oil)>1 to obtain base oil having a kinematic viscosity of 80 mm2/s. Alicyclic urea was synthesized in the base oil to obtain grease having worked penetration of 290, unworked penetration of 274, and unworked penetration of 282 after standing at a high temperature.

### Example 4

A PAO alone was used as base oil having a kinematic viscosity of 48 mm2/s. Alicyclic urea and aliphatic urea were synthesized in the base oil to obtain grease having worked penetration of 199, unworked penetration of 197, and unworked penetration of 200 after standing at a high temperature.

### Example 5

Ester oil alone was used as base oil having a kinematic viscosity of 100 mm2/s. Alicyclic urea and aliphatic urea were synthesized in the base oil to obtain grease having worked penetration of 265, unworked penetration of 245, and unworked penetration of 244 after standing at a high temperature.

### Comparative Example 1

A PAO alone was used as base oil having a kinematic viscosity of 48 mm2/s. Alicyclic urea and aliphatic urea were synthesized in the base oil as a thickener to obtain grease having worked penetration of 220, unworked penetration of 170, and unworked penetration of 158 after standing at a high temperature.

### Comparative Example 2

A PAO and ester oil were mixed at a mass ratio (PAO/ester oil)>1 to obtain base oil having a kinematic viscosity of 22 mm2/s. Alicyclic urea and aliphatic urea were synthesized in the base oil as a thickener to obtain grease having worked penetration of 232, unworked penetration of 178, and unworked penetration of 149 after standing at a high temperature.

### Comparative Example 3

The same base oil and thickener as in Example 1 were used, and a ratio of the thickener to the base oil was adjusted to obtain grease having worked penetration of 295, unworked penetration of 287, and unworked penetration of 236 after standing at a high temperature.

### Comparative Example 4

Mineral oil and a PAO were mixed at a mass ratio (mineral oil/PAO)≈1 to obtain base oil having a kinematic viscosity of 52 mm2/s. Alicyclic urea and aliphatic urea were synthesized in the base oil as a thickener to obtain grease having worked penetration of 248, unworked penetration of 164, and unworked penetration of 155 after standing at a high temperature.

With respect to the grease in Examples 1 to 5 and in Comparative Examples 1, 2, and 4, a durability test for the rolling bearing was performed under the following conditions. When the grease in Comparative Example 3 was used in the following rolling bearing, a variation in rotational resistance of each rolling bearing was larger than a predetermined required value, and a fluctuation in the rotational resistance with respect to an operating time occurred, so that the grease was determined to be unsuitable for a rolling bearing, and was excluded from a target of the durability test.

### Shape of Rolling Bearing

A rolling bearing having an outer ring with an outer diameter of 8 mm, an inner ring with an inner diameter of 3 mm, and a height (thickness in the axial direction) of 4 mm was used.

### Disposition of Grease

Twelve milligrams of grease were applied to a shape of the grease 60 in the first embodiment.

### Method for Evaluating Durability

Two rolling bearings using the same grease were incorporated into one fan motor (rated rotation speed 25000 rpm). For the grease in Examples 1 to 5 and in Comparative Examples 1 and 2, five fan motors were prepared, and continuously operated in a high temperature tank at 85° C. to check an operating state and occurrence of abnormal noise every 500 hours. Evaluation results are shown in Table 1.

TABLE 1

| | Comparative | Comparative | Comparative | Comparative | Example | Example | Example | Example | Example |
|---|---|---|---|---|---|---|---|---|---|
| | Example 1 | Example 2 | Example 3 | Example 4 | 1 | 2 | 3 | 4 | 5 |
| Thickener | Urea | Urea | Urea | Urea | Urea | Urea | Urea | Urea | Urea |
| Base oil | PAO | PAO/ester | Ester/PAO | Mineral | Ester/PAO | Ester/PAO | Ether/ester | PAO | Ester |
| | | | | oil/PAO | | | | | |
| Kinematic | 48 | 22 | 44 | 52 | 44 | 44 | 80 | 48 | 100 |
| viscosity of | | | | | | | | | |
| base oil | | | | | | | | | |
| (40° C.) | | | | | | | | | |
| Worked | 220 | 232 | 295 | 248 | 228 | 261 | 290 | 199 | 265 |
| penetration | | | | | | | | | |
| Unworked | 170 | 178 | 287 | 164 | 227 | 255 | 274 | 197 | 245 |
| penetration | | | | | | | | | |
| Worked | 50 | 54 | 8 | 84 | 1 | 6 | 16 | 2 | 20 |
| penetration − | | | | | | | | | |
| unworked | | | | | | | | | |
| penetration | | | | | | | | | |
| (Worked | 22.7 | 23.3 | 2.7 | 33.9 | 0.4 | 2.3 | 5.5 | 1 | 7.5 |
| penetration − | | | | | | | | | |
| unworked | | | | | | | | | |
| penetration)/ | | | | | | | | | |
| worked | | | | | | | | | |
| penetration | | | | | | | | | |
| (%) | | | | | | | | | |
| Unworked | 158 | 149 | 236 | 155 | 188 | 210 | 282 | 200 | 244 |
| penetration | | | | | | | | | |
| after | | | | | | | | | |
| standing at | | | | | | | | | |
| 85° C. for 18 | | | | | | | | | |
| hours | | | | | | | | | |
| Evaluation | Low | Low | Variation in | | | | | | |
| Results | durability | durability | rotational | | | | | | |
| | Occurrence | Stop | resistance is | | | | | | |
| | of abnormal | | large | | | | | | |
| | noise | | Fluctuation | | | | | | |
| | | | in the | | | | | | |
| | | | rotational | | | | | | |
| | | | resistance is | | | | | | |
| | | | large | | | | | | |

When the grease in Comparative Example 1 was used, occurrence of abnormal noise was confirmed in three of the five fan motors in an operating time of 3000 hours. When the grease in Comparative Example 2 was used, one of the five fan motors stopped at an operating time of 2000 hours, and two more stopped at an operating time of 2500 hours. On the other hand, when the grease in each of Examples 1 to 5 was used, the five fan motors were stably operated without abnormal noise even after an operating time of 5000 hours. From the above description, it is clear that, when the unworked penetration of the grease is greater than 178 and less than 287, it is possible to improve durability of the rolling bearing while preventing occurrence of variations in the rotational resistance of each rolling bearing. Further, it is clear that the durability of the rolling bearing can be reliably improved if a difference between the worked penetration and the unworked penetration is less than 50 while the unworked penetration of the grease satisfies the above conditions. It is clear that the durability of the rolling bearing can be reliably improved when the ratio of the difference between the worked penetration and the unworked penetration to the worked penetration is less than 22.7% while the unworked penetration of the grease satisfies the above conditions.

The invention is not limited to the embodiments described above with reference to the drawings, and various modifications are conceivable within the technical scope of the invention.

For example, in the above embodiment, the inner ring 10 is provided as a rotating ring, and the outer ring 20 is provided as a fixed ring. The grease 60, 160, 160A, 260, 260A, 360, 360A, 360B, 460, 460A, 460B, 560, and 560A is in contact with the outer ring 20 that is the fixed ring. However, the bearing ring with which the grease comes into contact may not be the fixed ring. That is, the inner ring may be provided as the fixed ring, the outer ring may be provided as the rotating ring, and the grease may be in contact with the inner ring that is the fixed ring. The inner ring may be provided as the fixed ring, the outer ring may be provided as the rotating ring, and the grease may be in contact with the outer ring that is the rotating ring.

In the above embodiments, the grease 60, 160, 160A, 260, 260A, 360, 360A, 360B, 460, 460A, 460B, 560, and 560A is in contact with the recessed portion over an entire circumference, but the invention is not limited to this configuration. The grease may be in contact with only a portion of the recessed portion in the circumferential direction.

A shape of the sealing member and an aspect of the contact portion between the sealing member and the grease are not limited to the above embodiment. For example, the sealing member may not have the extension portion, and may be formed such that the planar portion extends inward in the radial direction from the pedestal portion. For example, the grease may be in contact with both the planar portion and the extension portion of the sealing member, or may be in contact with the extension portion without being in contact with the planar portion. Since the grease has the properties of the above-described embodiment, if the grease is in contact with at least one of the planar portion and the extension portion, a shape of the portion of the grease 60 that is not in contact with the rolling body 30 and the cage 40 is easily maintained as the initial shape. Therefore, it is possible to prevent occurrence of variations in the rotational resistance due to a shape of the grease 60 being different for each rolling bearing 1.

In the above embodiments, the grease 60, 160, 160A, 260, 260A, 360, 360A, 360B, 460, 460A, 460B, 560, and 560A is not in contact with the inner ring 10 and the cage 40, but the invention is not limited to this configuration. As described above, in the above embodiment, it is possible to prevent the grease from spreading largely toward the inner ring 10 side and the rolling body 30 side when the sealing member 50 is mounted. Therefore, even if the grease comes into contact with at least one of the inner ring 10 and the cage 40, a contact portion can be made sufficiently small compared with a structure in the related art, and an effect of reducing the rotational resistance can be obtained.

In the above embodiment, the grease is disposed on the opposite side of the annular portion 41 of the cage 40 across the rolling body 30 in the axial direction. However, the grease may also be disposed on an annular portion 41 side of the cage 40 with respect to the rolling body 30 in the axial direction.

Grease other than the grease 60, 160, 160A, 260, 260A, 360, 360A, 360B, 460, 460A, 460B, 560, and 560A may be disposed in the rolling bearing. In the above embodiment, the grease is disposed on the opposite side of the annular portion 41 of the cage 40 across the rolling body 30 in the axial direction. However, the grease may also be disposed on the annular portion 41 side of the cage 40 with respect to the rolling body 30 in the axial direction. For example, the rolling bearing may further include grease applied to a grease pocket, a lower end surface, or the like of the cage.

Although the fan motor is exemplified as the rotating device in the embodiment, the rotating device is not limited thereto. For example, the invention may be applied to a dental handpiece, a spindle motor of a hard disk drive, and the like as the rotating device.

In the above embodiment, the grease is thickened only with urea synthesized in all the base oil, and no gelling agent is used.

In addition, components in the above-described embodiments can be appropriately replaced with well-known components without departing from the gist of the invention, and the above-described embodiments and modifications may be appropriately combined.

What is claimed is:

1. A rolling bearing comprising:
an inner ring and an outer ring disposed coaxially with each other;
a rolling body disposed between the inner ring and the outer ring;
a sealing member mounted on the inner ring or the outer ring and covering a space between the inner ring and the outer ring from an outer side in an axial direction; and
grease disposed between the rolling body and the sealing member, wherein
one bearing ring of the inner ring and the outer ring has a circumferential surface facing the other bearing ring,
the circumferential surface is formed with a raceway surface that supports the rolling body in a rollable manner, and a recessed portion that is provided at a location extending in the axial direction from an end edge of the raceway surface in the axial direction and is recessed in a radial direction,
the grease is in contact with the recessed portion, and
unworked penetration of the grease is greater than 178 and less than 287.

2. The rolling bearing according to claim 1, wherein
the grease is in contact with a location of the recessed portion that faces a direction inclined outward in the axial direction with respect to the radial direction.

3. The rolling bearing according to claim 1, wherein
the recessed portion has a location that faces a direction inclined inward in the axial direction with respect to the radial direction.

4. The rolling bearing according to claim 1, wherein
the grease is in contact with the sealing member.

5. The rolling bearing according to claim 1, wherein
the grease is in contact with a ridge portion formed at an end edge of the recessed portion on a raceway surface side.

6. The rolling bearing according to claim 1, wherein
the one bearing ring has a protruding portion that protrudes toward the other bearing ring side and on which the circumferential surface is formed,
the protruding portion has an end surface that faces outward in the axial direction and is connected to the circumferential surface at a circumferential edge on the other bearing ring side,
the circumferential surface has a connection surface formed between the recessed portion and the end surface, and
the connection surface is further away from the other bearing ring in the radial direction than an end edge of the raceway surface in the axial direction.

7. The rolling bearing according to claim 1, wherein
the circumferential surface includes an inclined portion extending from an end edge of the recessed portion on a raceway surface side toward the raceway surface side while being inclined with respect to the radial direction and the axial direction.

8. The rolling bearing according to claim 7, wherein
the grease is disposed so as not to protrude from an inner side of the recessed portion toward an inclined portion side in the radial direction.

9. The rolling bearing according to claim 1, wherein
a difference between worked penetration and the unworked penetration of the grease is less than 50.

10. The rolling bearing according to claim 1, wherein
a ratio of a difference between worked penetration and the unworked penetration to the worked penetration of the grease is less than 22.7%.

11. The rolling bearing according to claim 1, wherein
unworked penetration of the grease after standing at 85° C. for 18 hours is greater than 158.

12. A rotating device comprising:
a rotating body disposed to be rotatable;
a support body rotatably supporting the rotating body; and
the rolling bearing according to claim 1 interposed between the rotating body and the support body.

13. A method for manufacturing a rolling bearing,
the rolling bearing including
an inner ring and an outer ring disposed coaxially with each other,
a rolling body disposed between the inner ring and the outer ring,
a sealing member mounted on the inner ring or the outer ring and covering a space between the inner ring and the outer ring from an outer side in an axial direction, and
grease disposed between the rolling body and the sealing member,
one bearing ring of the inner ring and the outer ring having a circumferential surface facing the other bearing ring, and
the circumferential surface being formed with a raceway surface that supports the rolling body in a rollable manner, and a recessed portion that is provided at a location extending in the axial direction from an end edge of the raceway surface in the axial direction and is recessed in a radial direction,
the method for manufacturing a rolling bearing comprising:
an application step of applying the grease by bringing the grease into contact with the recessed portion, wherein
unworked penetration of the grease is greater than 178 and less than 287.

14. The method for manufacturing a rolling bearing according to claim 13, wherein
the sealing member includes
an annular pedestal portion that is in contact with the one bearing ring from the outer side in the axial direction,
an extension portion that extends outward in the axial direction from a circumferential edge of the pedestal portion on the other bearing ring side of the inner ring and the outer ring, and
a planar portion that extends along the radial direction from an end edge of the extension portion on the outer side in the axial direction toward the other bearing ring,
in the application step, the grease is applied so as to protrude outward in the axial direction and toward the other bearing ring side from a contact portion with the one bearing ring, and
the method for manufacturing a rolling bearing further includes:
a contact step of bringing the sealing member close to the one bearing ring from the outer side in the axial direction and bringing the planar portion into contact with an end edge of the grease on the outer side in the axial direction; and
after the contact step, a mounting step of bringing the sealing member close to the one bearing ring to bring the pedestal portion into contact with the one bearing ring from the outer side in the axial direction, and pressing the grease inward in the axial direction by the planar portion.
